(19) United States
(12) Patent Application Publication
(10) Pub. No.: US 2013/0002600 A1
(43) Pub. Date: Jan. 3, 2013

(54) TOUCH SENSITIVE DEVICE ADAPTIVE SCALING

(76) Inventor: David Harold McCracken, Aptos, CA (US)

(21) Appl. No.: 13/198,526

(22) Filed: Aug. 4, 2011

Related U.S. Application Data
(60) Provisional application No. 61/504,002, filed on Jul. 1, 2011.

(51) Int. Cl. G06F 3/044; G06F 3/041

(52) U.S. Cl. 345/174; 345/173

(57) ABSTRACT

A method for performing adaptive scaling in a touch sensitive device including a touch pad is provided. The method includes obtaining a trajectory of touch positions from the touch pad; setting a first scaling factor; comparing an acceleration factor to a deceleration factor, and: setting a second scaling factor to the acceleration factor if the first scaling factor is lower than the acceleration factor when the acceleration factor is greater than the deceleration factor; setting the second scaling factor to the deceleration factor if the first scaling factor is greater than the deceleration factor when the acceleration factor is lower than or equal to the deceleration factor; and updating the trajectory with a new touch position provided by the touch pad and a scaling factor set to the second scaling factor. A touch sensitive device coupled to a display for use with the above method is also provided.

### CROSS-RELATED APPLICATIONS

This application claims priority to U.S. Provisional Patent Application No. 61/504,002 filed Jul. 1, 2011, entitled “Touch Sensitive Device Adaptive Scaling” by David Harold McCracken, the disclosure of which is incorporated by reference in its entirety here for all purposes.

This application is related to U.S. patent application entitled “Touch Device Gesture Recognition” (Attorney Docket No. 70107.327) by David Harold McCracken, assigned to Integrated Device Technology, Inc. filed concurrently with the present disclosure on Aug. 4, 2011, and which is incorporated herein by reference in its entirety for all purposes. This application is also related to U.S. patent application Ser. No. 13/154,227, filed on Jun. 6, 2011, entitled “Differential Capacitance Touch Sensor” by David Harold McCracken, assigned to Integrated Device Technology, Inc. incorporated herein by reference in its entirety for all purposes.

### BACKGROUND

1. Technical Field

Embodiments described herein generally relate to the field of touch sensitive devices that transfer position data to a display device. More particularly, embodiments disclosed herein relate to methods to adjust scaling in touch sensitive devices according to user intent.

2. Description of Related Art

In the field of touch sensitive devices the display typically has a surface area that may be much larger than the sensitive area in the touch sensitive pad. To adjust for the different sizes between the sensitive pad and the display a scaling factor is used to transform a position on the pad to a position on the display. As the user moves a cursor over the display, it may need precise positioning to reach a specific target on the display. In other occasions, the user may need to translate a cursor or a pointer across a large portion of the display, in a long, fast slide motion. While precise positioning may use a small scaling factor for the translation from the touch sensitive pad to the display, a long slide motion may use a larger scaling factor. This presents the problem of adjusting the scale of the motion translation according to the user needs. Furthermore, the adjustment is preferably performed in a timely manner, to avoid sluggishness in the response, also allowing the user some range for a jittery, indecisive motion.

Current state-of-the-art solutions to the problem of scaling in touch sensitive devices implement a speed-based correction factor. According to these solutions, the scaling factor is adjusted by measuring the acceleration of a finger motion in the touch pad. Thus, for example, a larger scaling factor resulting in larger display movements is implemented for faster movement in the touch pad. Likewise, a smaller scaling factor resulting in more precise display movements is implemented for a decelerating movement in the touch pad. However, a speed-based approach fails to accurately follow a user's intent in many circumstances. For example, a fast moving touch may incorrectly suggest that the user intends to move a cursor on the display further away. Another problem with a speed-based approach is that the instantaneous speed of a single stroke or slide may vary substantially from the start point to the end point. Unless there is a mechanism to interpret sudden changes in speed, the device may become sluggish if simple averaging of the speed is used. These problems are exacerbated for systems using small input touch devices, since accelerated movements are more frequent in these systems.

What is needed is a touch sensitive device and a method for using a touch sensitive device that accurately and rapidly adjusts the translation scale according to user intent.

### SUMMARY

According to embodiments disclosed herein, a method for performing adaptive scaling in a touch sensitive device including a touch pad having a sensing range and a display having a display range may include: obtaining a trajectory of touch positions from the touch pad; setting a first scaling factor; comparing an acceleration factor to a deceleration factor, and: setting a second scaling factor to the acceleration factor if the first scaling factor is lower than the acceleration factor when the acceleration factor is greater than the deceleration factor; setting the second scaling factor to the deceleration factor if the first scaling factor is greater than the deceleration factor when the acceleration factor is lower than or equal to the deceleration factor; and updating the trajectory with a new touch position provided by the touch pad and the second scaling factor.

According to embodiments disclosed herein, a method for scaling a movement on a sensitive pad to a movement on a display may include obtaining a trajectory from the sensitive pad; setting a first scaling factor; obtaining a speed of motion from the trajectory; obtaining a measure for a short-range movement on the sensitive pad; computing an acceleration factor proportional to the speed of motion; computing a deceleration factor proportional to the measure for a short-range movement; comparing the deceleration factor to the first scaling factor, and: setting a second scaling factor to the acceleration factor if the first scaling factor is lower than the acceleration factor when the deceleration factor is greater than or equal to the first scaling factor; setting the second scaling factor to the deceleration factor if the first scaling factor is greater than or equal to the acceleration factor when the deceleration factor is lower than the first scaling factor; setting the second scaling factor to a weighted average of the acceleration factor and the deceleration factor if the first scaling factor is greater than the deceleration factor and the acceleration factor is greater than the first scaling factor; and updating the trajectory with the second scaling factor.

Further according to embodiments disclosed herein a method for performing adaptive scaling in a touch sensitive device including a touch pad having a sensing range and a display having a display range may include: obtaining a trajectory of touch positions from the touch pad; setting a direction factor; and adjusting a first scaling factor in a first direction and a second scaling factor in a second direction using the direction factor and a coarse direction of the trajectory. The method may further include updating the trajectory with a new touch position in the first direction using the first scaling factor and in the second direction using the second scaling factor.

A method for performing adaptive scaling in a touch sensitive device including a touch pad having a sensing range and a display having a display range according to embodiments disclosed herein may include: obtaining a trajectory of touch positions from the touch pad; obtaining a first value proportional to a long range performance; obtaining a second value proportional to a short range performance; adjusting a scaling factor using a difference between the first value and the second value; and updating a trajectory on the display with a new touch position using the scaling factor.

A method for performing adaptive scaling in a touch sensitive device including a touch pad having a sensing range and a display having a display range according to embodiments disclosed herein may include the steps of: obtaining a trajectory of touch positions from the touch pad; setting a first scaling factor; obtaining an acceleration factor proportional to a speed of motion of a touch; obtaining a deceleration factor proportional to a measure of an envelope; identifying the location of a target object in the display; increasing the acceleration factor when the trajectory overlaps the target object; decreasing the acceleration factor when the trajectory ceases to overlap the target object; setting a second scaling factor to the acceleration factor when the acceleration factor is greater than the deceleration factor; setting the second scaling factor to the deceleration factor when the first scaling factor is greater than the deceleration factor and the acceleration factor is lower than or equal to the deceleration factor; and updating the trajectory with a new touch position provided by the touch pad and the second scaling factor.

According to embodiments disclosed herein a touch sensitive device coupled to a display, the touch sensitive device having a touch pad and a controller may include: a processor circuit coupled to receive data from the touch pad, wherein the processor circuit obtains a touch location from the data provided by the touch pad; a memory circuit coupled to receive and store the touch location from the processor circuit and form a trajectory from a plurality of touch locations; wherein the processor circuit obtains an instantaneous speed and a moving envelope having a measure from the trajectory stored in the memory circuit; and the controller provides a signal to the display to move an indicator to a position on the display; and the position on the display is obtained by the processor circuit using the touch location and a scaling factor computed using the instantaneous speed and the envelope measure.

These and other embodiments of the present invention are further described below with reference to the following figures.

### BRIEF DESCRIPTION OF THE DRAWINGS

FIG. 1 illustrates a partial view of a touch sensitive device and a display according to embodiments disclosed herein.

FIG. 2A illustrates a flowchart of a method for filtering jitter motion of a touch sensitive device according to embodiments disclosed herein.

FIG. 2B illustrates a jitter-filtered trajectory in a touch sensitive device according to embodiments disclosed herein.

FIG. 3 illustrates a direction quantization chart according to embodiments disclosed herein.

FIG. 4A illustrates a flowchart of a method for obtaining an inflection path in a touch sensitive device according to embodiments disclosed herein.

FIG. 4B illustrates an inflection path in a touch sensitive device obtained according to methods disclosed herein.

FIG. 5A illustrates a flowchart of a method for obtaining a movement envelope in a touch sensitive device according to embodiments disclosed herein.

FIG. 5B illustrates a series of moving envelopes in a touch sensitive device obtained according to methods disclosed herein.

FIG. 6A illustrates a motion path and a resulting envelope having a Dy and a Dx displacement obtained according to embodiments disclosed herein.

FIG. 6B illustrates a motion path and a resulting envelope having a Dy and a Dx displacement obtained according to embodiments disclosed herein.

FIG. 6C illustrates a motion path and a resulting envelope having a Dy and a Dx displacement obtained according to embodiments disclosed herein.

FIG. 7A illustrates a flowchart of a method for obtaining a scaling factor in a touch sensitive device using two terms, according to embodiments disclosed herein.

FIG. 7B illustrates a flowchart of a method for obtaining a scaling factor in a touch sensitive device using two terms, according to embodiments disclosed herein.

FIG. 8 illustrates a flowchart of a method for obtaining a direction-sensitive scaling factor in a touch sensitive device according to embodiments disclosed herein.

FIG. 9A illustrates a flowchart of a method for obtaining a user-sensitive scaling factor having long range performance (LRP), according to embodiments disclosed herein.

FIG. 9B illustrates a flowchart of a method for obtaining a user-sensitive scaling factor having a short range performance (SRP), according to embodiments disclosed herein.

FIG. 9C illustrates a flowchart of a method for obtaining scaling factors balancing an LRP and an SRP, according to some embodiments disclosed herein.

FIG. 10 illustrates a display coupled to a touch sensitive device using a target-aware scaling method, according to embodiments disclosed herein.

FIG. 11A illustrates a flow chart of a method for extending a boundary in a touch sensitive device according to embodiments disclosed herein.

FIG. 11B illustrates a flow chart of a method for extending a boundary in a touch sensitive device according to embodiments disclosed herein.

FIG. 11C illustrates a display coupled to a touch sensitive device using a boundary extension method according to embodiments disclosed herein.

FIG. 12A illustrates an apparent position of a finger in a touch pad coupled to a touch sensitive device configured to avoid an edge rollback, according to embodiments disclosed herein.

FIG. 12B illustrates an apparent position of a finger in a touch pad coupled to a touch sensitive device configured to avoid an edge rollback, according to embodiments disclosed herein.

FIG. 12C illustrates an apparent trajectory of a finger in a touch pad coupled to a touch sensitive device configured to avoid an edge rollback, according to embodiments disclosed herein.

FIG. 12D illustrates apparent trajectories of a finger in a touch pad coupled to a touch sensitive device configured to avoid an edge rollback, according to embodiments disclosed herein.

FIG. 13A illustrates a partial side view of a touch sensitive device configured to avoid an “untouch jump” according to embodiments disclosed herein.

FIG. 13B illustrates a partial side view of a touch sensitive device configured to avoid an “untouch jump” according to embodiments disclosed herein.

FIG. 13C illustrates a partial side view of a touch sensitive device configured to avoid an “untouch jump” according to embodiments disclosed herein.

FIG. 14 illustrates a flowchart of a method for avoiding an “untouch jump” in a touch sensitive device according to embodiments disclosed herein.

In the figures, elements having the same designation have the same or similar functions.

### DETAILED DESCRIPTION

Embodiments disclosed herein relate to the use of a touch sensitive device where the touch position on a touch pad is translated to a corresponding position in another domain, such as a screen display. In some embodiments, the two domains (touch pad/screen display) may have significantly different resolution or size. In such cases, a one-to-one mapping between the touch sensitive device and the display is not practical. An example of such configuration may be a computer touchpad, where a display cursor (and, by implication, the point at which some action may be applied by the user) is moved by sliding a finger on a touch pad. The pad may be smaller and of lower resolution than the display. If the pad is mapped to the entire display, the user may lose precision to place the cursor on the display screen. If the pad is mapped for finer resolution, the user may not reach some portions of the display.

In some embodiments, an input touch pad may afford the same or higher resolution than the display. However, if the touch pad is small, such as a differential capacitive positioning device, the user may be unable to precisely position the cursor on the display due to finger jitter or electronic noise. In this case, the primary problem to be solved is position jitter resulting from involuntary operator movement, random environmental capacitance, ground changes, and electrical noise in the capacitance measuring circuitry. Some embodiments consistent with the disclosure herein may include a touch screen device, where the mapping from the touch sensitive device to the display is one to one. This may be referred to as a 100% scaling.

Sources of jitter are common in touch sensitive devices; however, in small size and high resolution devices according to embodiments disclosed herein, jitter may be substantially amplified on the display. In high resolution devices, a touch pad position may be mapped to the entire display without experiencing the quantization error of a lower resolution touch pad. However, the jitter from such a mapping may substantially reduce positioning accuracy, regardless of resolution.

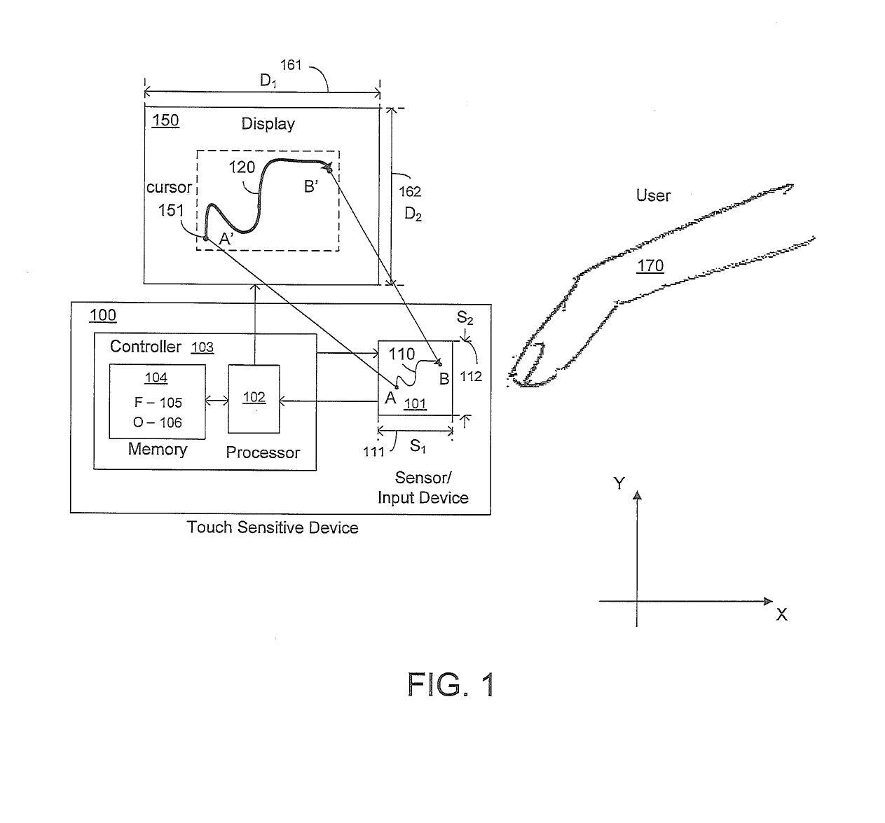

FIG. 1 illustrates a partial view of touch sensitive device 100 and display 150, according to embodiments disclosed herein. Touch sensitive device 100 may include touch pad 101, or the sensor input, which is coupled to controller 103, including processor 102 and memory 104. Controller 103 provides power to touch pad 101. Touch pad 101 provides a signal to processor 102 upon being touched by finger 170 from a user. Relative dimensions in FIG. 1 are for schematic clarity only and do not necessarily reflect actual sizes. In some embodiments, touch pad 101 includes a capacitive sensing circuit. Display 150 may be coupled to touch pad 101 through electrical connections in a computer, laptop device, palm-held electronic device, or some other portable electronic appliance. Furthermore, display 150 may be coupled to touch pad 101 through a wireless connection operating at a radio frequency (RF), or through an infrared beam device. In some embodiments, touch pad 101 may be included as part of display 150.

A touch by the user may also be executed by other capacitive devices such as a pen pointer, a stylus, or any other dielectric device having a narrow tip, according to embodiments consistent with FIG. 1. An XY coordinate system is shown for ease of reference hereinafter. Choice of the Y-coordinate along the vertical direction and the X-coordinate along the horizontal direction is arbitrary and may vary from one embodiment to another. Processor 102 converts the signal provided by touch pad 101 into a touch position having (X, Y) coordinates. Furthermore, processor 102 may also perform mathematical operations to convert the (X, Y) coordinates from a touch in touch pad 101 into (X′, Y′) coordinates of cursor 151 on display 150.

Display 150 may be a computer display, such as the liquid crystal display (LCD) on a laptop computer, or the screen in a smart phone or any other handheld device such as a cell phone, a camera, a PDA or a tablet. The (X′, Y′) coordinates on display 150 may represent the position of a cursor, or a cross-hair, or a visual mark indicating the user a specific location on display 150. Thus, according to embodiments consistent with FIG. 1, touch sensitive device 100 may translate finger trajectory 110 on touch pad 101 onto display trajectory 120 on display 150. While trajectory 110 starts at point A and ends at point B on touch pad 101, trajectory 120 starts at point A′ and ends at point B′ on display 150. The mathematical transformation from point (X, Y) into point (X′, Y′) is performed by processor 102 using a set of parameters including scaling factor 105 (F), and offset vector 106 (O). Scaling factor 105 and offset vector 106 may be stored in memory 104, and modified by processor 102. Scaling factor 105 is a number that relates displacements X and Y in touch pad 101 to displacements X′ and Y′ on display 150. Offset vector 106 includes the X′(Ox) and Y′(Oy) coordinates of an offset, position on display 150. For example, an offset position may be the location of cursor 151 after a prior touch has been lifted from touch pad 101. Thus, according to some embodiments, processor 102 may perform the following mathematical operation on coordinates X, Y to obtain coordinates X′, Y′:

X′=Ox+F·X (1.1)

Y′=Oy+F·Y (1.2)

The choice of the origin in coordinate system XY is arbitrary, and may be adjusted by processor 102 through offset 106. Equations (1.1) and (1.2) are illustrative only, some embodiments disclosed herein may use a different combination of operations with scaling factor 105 and offset 106 in order to obtain display position (X′, Y′) from touch pad position (X, Y).

The XY dimensions of touch pad 101, are S₁(111)-S₂(112) respectively. Likewise, the XY dimensions of display 150 are D₁(161)-D₂ (162), respectively. Consistent with some embodiments, display 150 may have a 100% scaling factor, such that the entire area S₁×S₂ of pad 101 is mapped onto the entire area D₁×D₂ of display 150. For example, in some embodiments touch pad 101 having S₁(111)=10 mm and S₂(112)=10 mm may be fully mapped to display 150 having D₁(161)=400 mm and D₂(162)=400 mm. In such conditions, the user can position the cursor anywhere in the display by touching the corresponding point on the input pad. This affords instantaneous positioning with little precision. Display 150 may include 2000 addressable points (pixels) in both directions. If touch pad 101 has equivalent resolution, moving cursor 151 to a specific pixel on display 150 corresponds to finger 170 having a movement resolution of 5 micrometers. Such resolution is substantially less than typical finger jitter.

According to embodiments consistent with the present disclosure touch sensitive device 100 may include a small touch pad 101 and a larger display 150, mapping pad 101 to a portion of display 150 with a small F 105. In this case processor 102 implements a variable offset 106 in order for the user to reach all positions in display 150 from pad 101. For example, pad 101 may include an area S₁×S₂=10×10 mm, with cursor 151 starting in the middle of display 150, and finger 170 touching the upper left corner of pad 101. If finger 170 slides diagonally to the lower right corner of pad 101, the cursor may move the same real distance (approximately 14 mm) to the lower right corner of the mapped area if scaling factor 105(F) is one (1). If finger 170 is lifted from pad 101 to touch down again in the upper left corner of pad 101, cursor 151 does not move on display 150. Instead, offset vector 106 (O) is increased accordingly to produce a smooth slide of cursor 151 on display 150. Using offset vector 106 (O) enables further movement in the same direction, when a small scaling factor 105 is used.

However, when small F 105 is used, to traverse the full diagonal in display 150 finger 170 would have to be repositioned and moved 40 times in the configuration discussed above. In embodiments disclosed herein the scaling factor 105 and the offset vector 106 in a controller for a touch pad are adaptively adjusted in response to apparent user intent. This enables rapid movement of cursor 151 across a large display area and precise, jitter-free movement when the user indicates an intention for it. Scaling changes are made transparent to the user by simultaneously changing offset vector 106 to retain the current cursor position at every lift-off motion by finger 170.

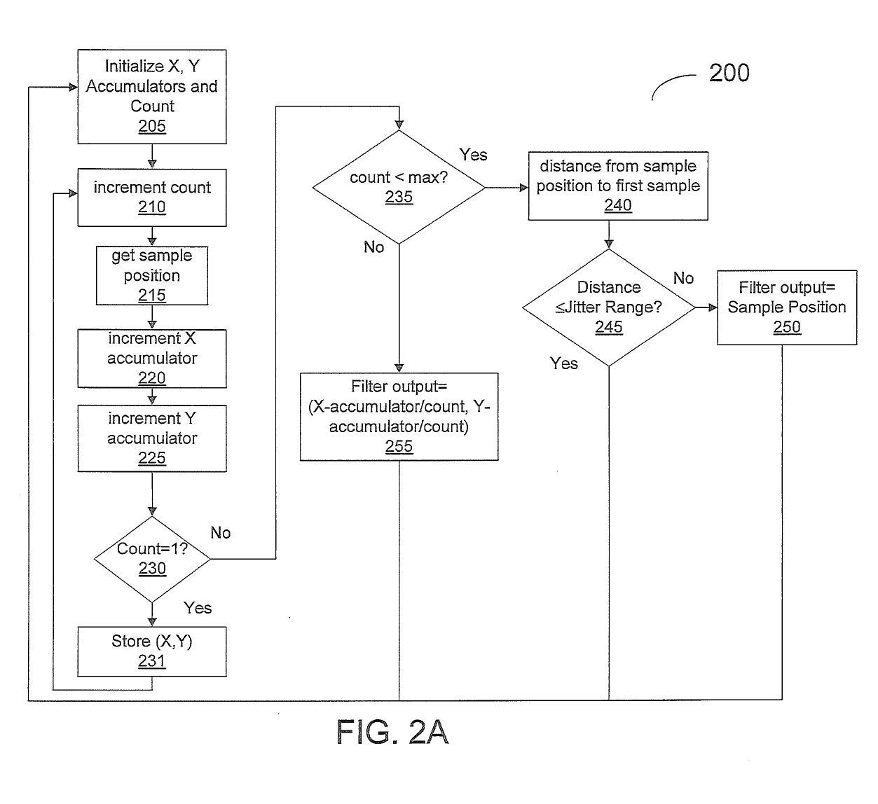

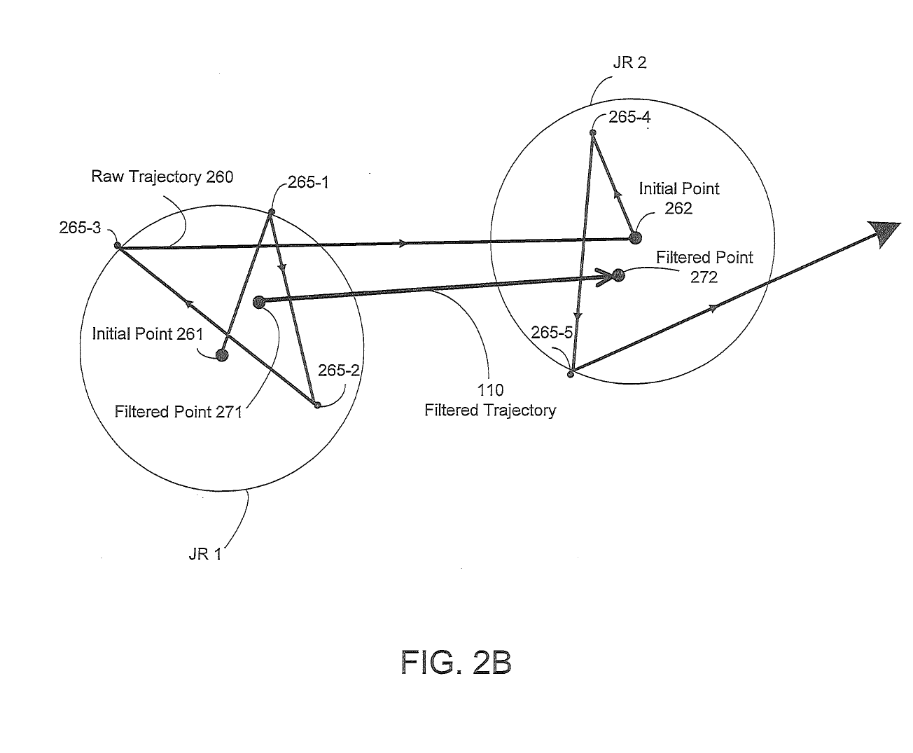

User intent may be detected by sub-perceptive touch gestures. Sub-perceptive touch gestures are natural and consistent patterns of touch movement requiring no user training. Unlike perceptive gestures, sub-perceptive gestures may not correspond to specific application functions. A two-finger “pinch” is a perceptive gesture that may be mapped to image size control. Sub-perceptive gestures have a broader character. Therefore, a larger set of motion characteristics may need to be determined in order to identify user intent from sub-perceptive gestures. In order to have an accurate assessment of sub-perceptive gestures, controller 103 filters touch positions provided by processor 102 from pad 101, to remove motion jitter introduced by finger 170. A method to achieve jitter motion filtering is described in detail in relation to FIG. 2A, below.

FIG. 2A illustrates a flowchart of method 200 for filtering jitter motion of touch sensitive device 100 according to embodiments disclosed herein. The steps shown in FIG. 2A may be performed in controller 103 by processor 102, coupled to memory 104 and receiving data from touch pad 101, according to embodiments consistent with the present disclosure. In step 205, X and Y accumulators, and a counter (count) are initialized to a predetermined value. In some embodiments, this predetermined value may be the same for X, Y accumulators and counter, and equal to zero (0). In 210 ‘count’ is incremented by one (1). In 215, a sample position is obtained in processor 102 by data provided from touch pad 101. The data provided by touch pad 101 may be electronic data representing a capacitance value, or a change in a capacitance value, according to some embodiments. In some embodiments, the data provided by touch pad 101 may be electronic data representing the power of an optical signal, or the power difference between two or more optical signals. In general, the specific nature of data provided by touch pad 101 may vary according to different applications of embodiments consistent with the present disclosure. Obtaining a sample position from data provided by touch pad 101 may include performing mathematical operations with the data in processor 102. The specific nature of the mathematical operations performed by processor 102 in order to obtain a touch position (X,Y) in step 215 vary according to the application of embodiments disclosed herein. The geometry of touch pad 101 and the nature of the signal provided, whether a capacitive value, an optical value, or else may also determine the specific nature of the mathematical operations by processor 102 to obtain (X,Y).

In step 220, the X accumulator is incremented by the value obtained in step 215 for the X-coordinate of touch position (X,Y). Likewise, in step 225 the Y accumulator is incremented by the value obtained in step 215 for the Y-coordinate of touch position (X,Y). The value of ‘count’ is verified in step 230. If ‘count’=1, then the sample position, which is the first point (X₁, Y₁) obtained in step 215, is stored in memory 104 and method 200 repeats from step 210.

If ‘count’ is different from one (1), it is then compared to a predetermined maximum count ‘max’ in step 235. The value of ‘max’ may be determined by user history, and also by considerations such as the responsiveness of touch sensitive device 100. A larger value of ‘max’ allows for a more accurate determination of user intent to move beyond a jitter range, but may also slow down the responsiveness of touch sensitive device 100.

If ‘count’ is less than ‘max,’ in step 240 the distance ‘D’ from the current sample point (X,Y) to point (X₁,Y₁) is obtained. In step 245, the value of D is compared to jitter range ‘JR.’ The value of JR is a predetermined value that represents the range of jitter for a user. Jitter range JR may be the displacement of finger 170 allowed by touch sensitive device 100 while assuming the user does not intend to actually move cursor 151 on display 150. In some embodiments, JR may also represent inadvertent departures from a desired trajectory of motion by the user. The value JR is stored in memory 104 and may be modified by processor 102 according to the history of the user movements. In some embodiments consistent with FIG. 2A, the value of JR may vary from one user to another, and memory 104 may keep a registry of JR values for each user. If step 245 determines that D is less than or equal to JR, then point (X,Y) is not used to move cursor 151 on display 150. Rather, steps 205 through 235 are repeated as described above. Note that even if cursor 151 is not moved on display 150 the values of X and Y are still collected in X-accumulator and Y-accumulator, respectively.

If step 245 determines that D is greater than JR, then the filter output (Fx, Fy) is updated to sample position (X,Y) in step 250. Thus, processor 102 uses position (X,Y) to place cursor 151 in position (X′,Y′) of display 150. For example, in embodiments consistent with FIG. 2A, processor 102 may use (X,Y) in formulas such as Eqs. (1.1) and (1.2) above to obtain (X′,Y′). Once the filter output is completed, steps 205 through 235 are repeated, as described above.

If ‘count’ is greater than or equal to ‘max’ according to step 235, then the filter output is determined to be (Fx, Fy) in step 255. The x-coordinate of the filter output, Fx, is the value stored in X-accumulator divided by the ‘count’ value. Likewise, the y-coordinate of the filter output, Fy, is the value stored in Y-accumulator divided by the ‘count’ value. Thus, even if touch position (X,Y) remains within jitter range from the initial position (X₁,Y₁), the position (X,Y) may be used by processor 102 to calculate a cursor position (X′,Y′). This may happen if finger 170 lingers near (X₁,Y₁) for long enough time to accrue a ‘count’ value greater than or equal to ‘max.’

FIG. 2B illustrates jitter-filtered trajectory 110 in touch sensitive device 100 according to embodiments disclosed herein. Raw trajectory 260 includes initial point 261 and initial point 262. Also included in trajectory 260 are sample points 265-1 through 265-5, used by processor 102 in a jitter filter as described above in relation to FIG. 2A. Filtered trajectory 110 is composed of filtered points 271 and 272 resulting from a filter output (Fx, Fy) according to embodiments consistent with the present disclosure. Note that, as depicted in FIG. 2B, the precise location of filter output (Fx, Fy), such as points 271 and 272 may not be an actual sample point in the raw trajectory. In some instances, a filter output (Fx, Fy) may be a sample point, such as when the distance of a sample point from an initial point is greater than JR. Note that, according to embodiments consistent with methods described herein, the distance between points 271 and 272 may be smaller than JR. In the example shown in FIG. 2B, method 200 has ‘max’=3, rendering points 271 and 272. Having a trajectory 110 of points in touch pad 101 free of jitter enables the application of strategies for detecting sub-perceptive gestures, such as the inflection path strategy.

Processor 102 produces filtered trajectory 110 including points 271 and 272, and also including time stamps for each of the trajectory points. Time stamps may be obtained by using a clock circuit included in processor 102, according to some embodiments. Trajectory 110 and the time stamps for each point in the trajectory are stored in memory 104. Time stamps may be used to calculate instantaneous speed of motion for each point in trajectory 110 in some embodiments.

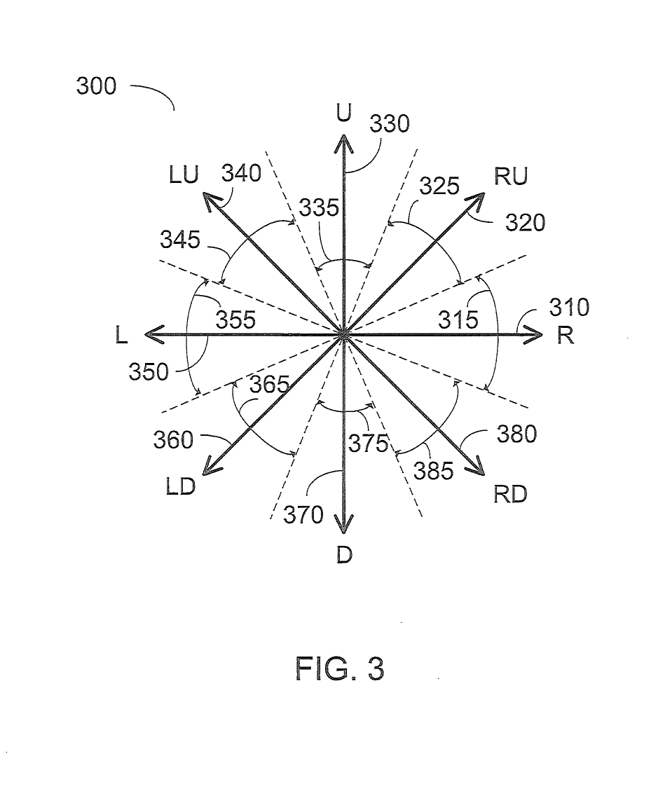

Sub-perceptive gestures may be identified by touch position history. Touch position history may be stored by controller 103 in memory 104. Some embodiments consistent with the present disclosure may include at least three levels of touch position history. A more immediate level records the instantaneous direction and speed of movement. A second level may store recent direction, speed, and distance for a relatively low number of positions, for example 5 or 6. A third level may include overall movement pattern using the entire touch position history during a given period of time. Instantaneous direction and speed are based on current and previous positions, as obtained from the output of a jitter filter procedure as illustrated in FIG. 2A. Recent direction and speed are based on current position and the most recent major inflection point. Inflection point is where the user deliberately changes direction of touch movement. According to some embodiments, an inflection includes a significant change in direction followed by significant movement without resuming the previous direction. A new recent direction and speed vector begins at the inflection. Vector history is one form of movement pattern that uses an inflection path strategy. The inflection path strategy uses a direction quantization chart as illustrated in detail in FIG. 3.

FIG. 3 illustrates direction quantization chart 300 according to embodiments disclosed herein. Chart 300 includes left-right directions (L-R) 350 and 310, respectively; and up-down directions (U-D) 330 and 370, respectively. Some embodiments may also include intermediate directions RU (right-up) 320, LD (left-down) 360, LU (left-up) 340, and RD (right-down) 380. Each of the selected directions 310, 320, 330, 340, 350, 360, 370, and 380 is centered on a corresponding direction interval 315, 325, 335, 345, 355, 365, 375, and 385, respectively. According to the chart depicted in FIG. 3, a displacement vector (X,Y) having a certain direction will be assigned one of the 310 through 380 directions if it lays within its corresponding direction interval. For example, a displacement vector pointing within direction interval 325 is assigned direction RU 320, according to embodiments consistent with the present disclosure. According to embodiments disclosed herein, an ‘inflection point’ in a trajectory occurs when the direction assigned to a displacement vector changes from one sample point to another. Thus, if a first sample point produces a displacement vector in the R 310 direction and the next sampling point produces a displacement vector in the RU 320 direction, then the first sample point may be characterized as ‘inflection point.’

The characterization of an ‘inflection point’ is arbitrary, and may vary for different embodiments according to the application used. For example, in some embodiments an ‘inflection point’ may be characterized only by drastic changes in direction, such as R 310 to L 350, or U 330 to D 370.

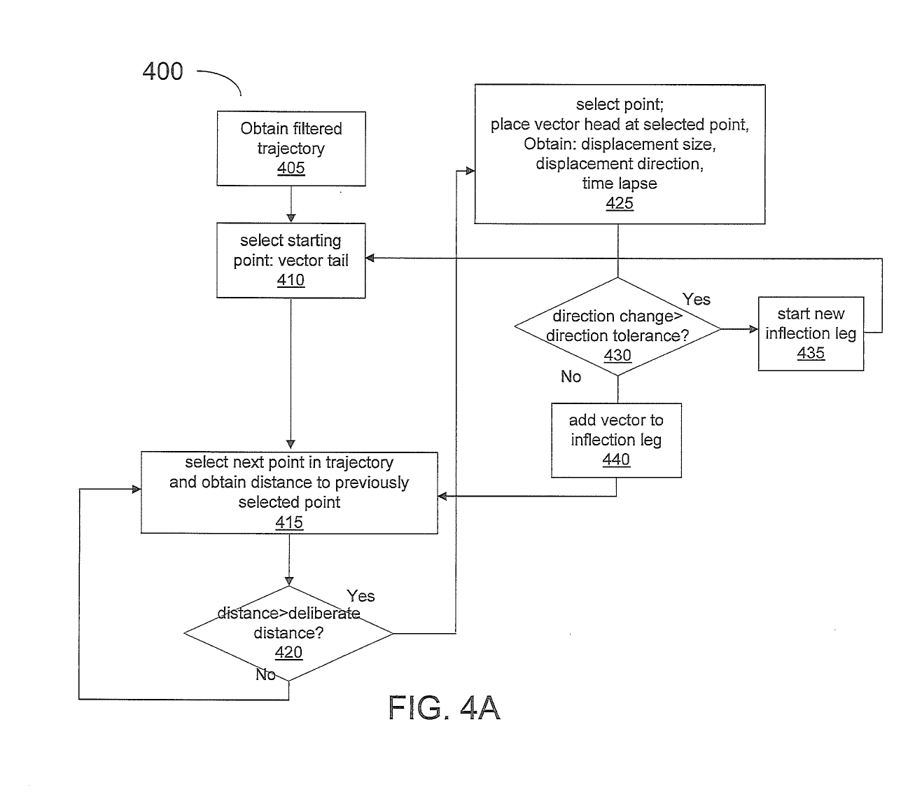

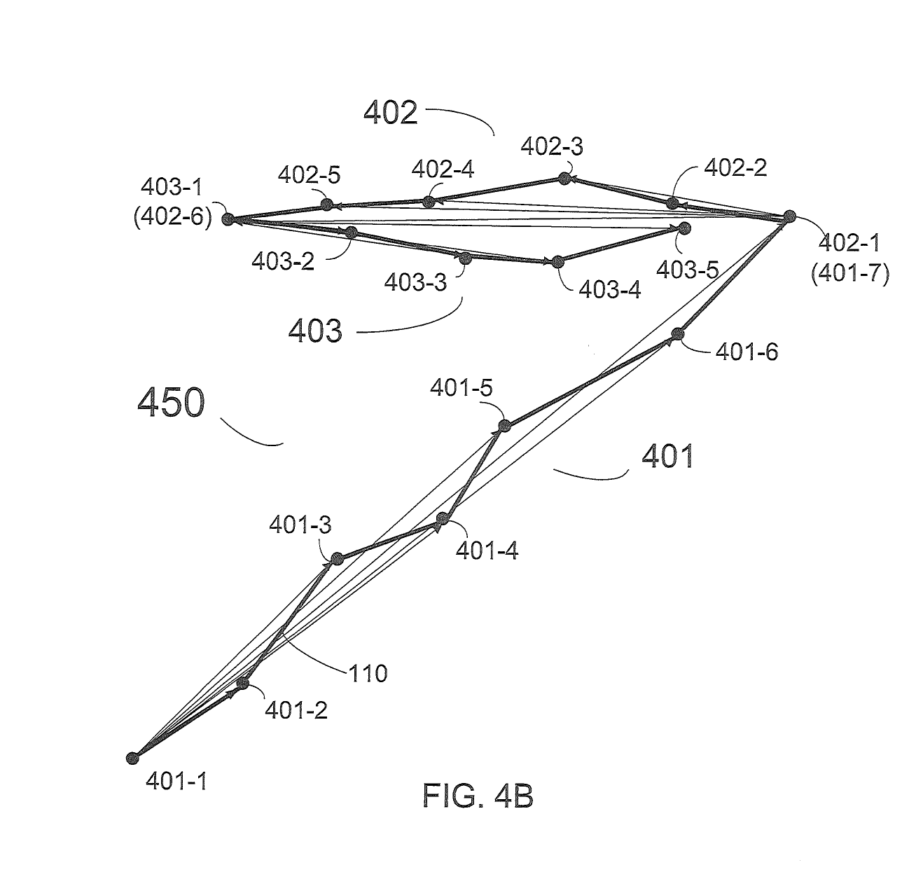

FIG. 4A illustrates a flowchart of method 400 for obtaining an inflection path in touch sensitive device 100 according to embodiments disclosed herein. In step 405 a time-ordered stream of touch positions forming trajectory 110 is collected from jitter filter 200 (cf. FIG. 2A). Method 400 may be implemented by processor 102 using data stored in memory 104, according to some embodiments consistent with the present disclosure. Included with trajectory 110 may also be a list of time stamps for each of the points in trajectory 110. A starting point for a current inflection leg is selected from trajectory 110 in step 410, placing a vector tail at this point. An inflection leg is a set including vectors having a common tail point in an inflection point, and heads along points in trajectory 110 selected as in steps 420-425, together with their time stamps. In step 415 the next point in trajectory 110 is selected, and its distance ‘Dt’ to the previously selected point, is calculated. In step 420 the value of Dt is compared to a ‘deliberate distance.’ The ‘deliberate distance’ in step 420 is a pre-selected value that represents a measure of an intentional movement by the user.

If Dt is lower than or equal to the ‘deliberate distance,’ then step 415 is repeated as described above. Steps 415 and 420 are repeated until a new point (X,Y) in trajectory 110 is obtained such that Dt is greater than ‘deliberate distance.’ In step 425, the new point (X,Y) is selected and vector V whose tail is the starting point in step 410 is completed with its head in selected point (X,Y). Vector V has a size, δᵥ, and a direction θᵥ. Also in step 425, a displacement vector S is obtained as the difference between current vector V and a prior vector V in the current inflection leg. Vector S has a displacement size δₛ(=Dt), a displacement direction θₛ and a time lapse τₛ. Time lapse τₛ may be obtained by subtracting the time stamps of the two most recently selected vector heads, and may be used to determine an instantaneous speed vₛ at the selected point as vₛ=δₛ/τₛ.

In step 430 a direction change Δθ is calculated using directions θᵥ and θₛ. Direction change Δθ is compared to a direction tolerance θₜₒₗ. If Δθ is smaller or equal to θₜₒₗ, then vector V is added to the current inflection leg in step 440, together with the time stamp of point (X,Y). Method 400 then continues as described in step 415. If Δθ is greater than θₜₒₗ, then a new inflection leg is started including point (X,Y) and the last point in the previous inflection leg, in step 435. Thus, the last point of a given inflection leg may be the first point of the next inflection leg, according to embodiments consistent with the methods disclosed herein. The first point of an inflection leg is called ‘inflection point’ I. The distance δₛ between the second point in an inflection leg and the inflection point is δ_{sI}. Having started a new inflection leg, step 410 is repeated, as detailed above, with inflection point I being the point collected prior to the new point (X,Y).

In some embodiments, the value Δθ obtained in step 430 is the absolute value of the difference between θᵥ for new point (X,Y) and the most recent point in the current inflection leg. Also, θₜₒₗ may be obtained from a direction interval selected from any of 315, 325, 335, 345, 355, 365, 375, or 385 (cf. FIG. 3). The direction interval to determine θₜₒₗ may be selected so that all vectors in a given inflection leg belong to the same direction interval. Some embodiments may include a more lax condition to select θₜₒₗ in step 430. For example, θₜₒₗ may be selected so that all vectors in a given inflection leg belong to two or more adjacent direction intervals—e.g. intervals 315, 325 and 385, cf. FIG. 3—. In some embodiments consistent with methods disclosed herein, Δθ may be obtained in step 430 using the direction of vector θₛ. For example Δθ may be the absolute value of the difference between θₛ and one of selected directions 310, 320, 330, 340, 350, 360, 370, and 380.

FIG. 4B illustrates inflection path 450 in touch sensitive device 100 obtained according to method 400. Inflection path 450 includes inflection legs 401, 402, and 403. Inflection leg 401 includes points 401-1 through 401-7. Inflection leg 402 includes points 402-1 through 402-6. And inflection leg 403 includes points 403-1 through 403-5. Inflection legs 401-403 are defined by inflection points I: 401-1, 402-1 (401-7), and 403-1 (402-6). It is clear that a change in direction occurs at each of the inflection points selected. All of the points in inflection legs 401, 402, and 403 belong to filtered trajectory 110. However, in some embodiments consistent with methods disclosed herein some of the points in filtered trajectory 110 may not be included in an inflection leg.

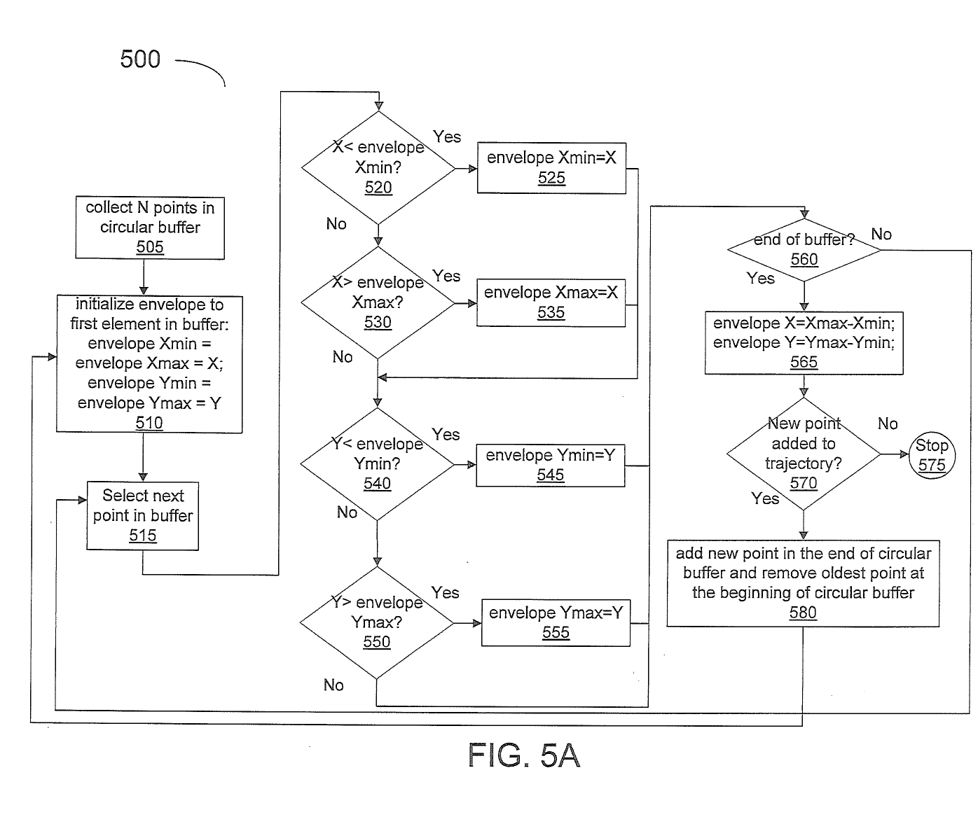

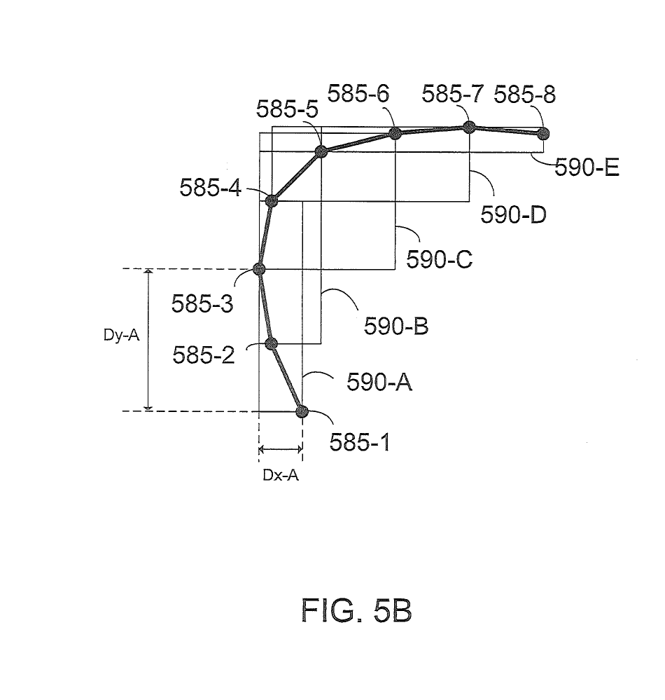

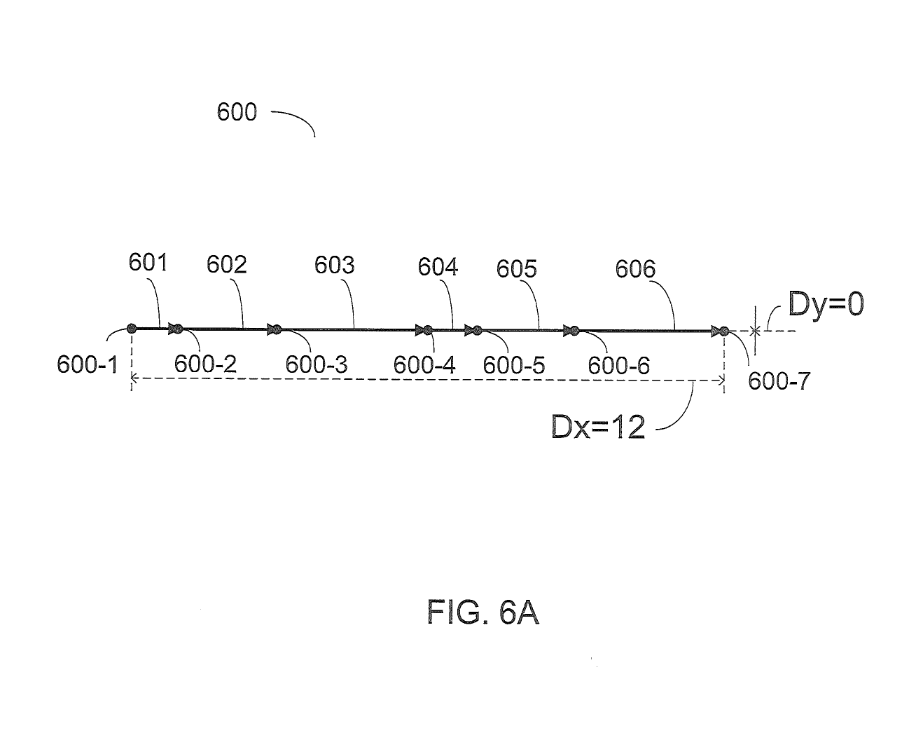

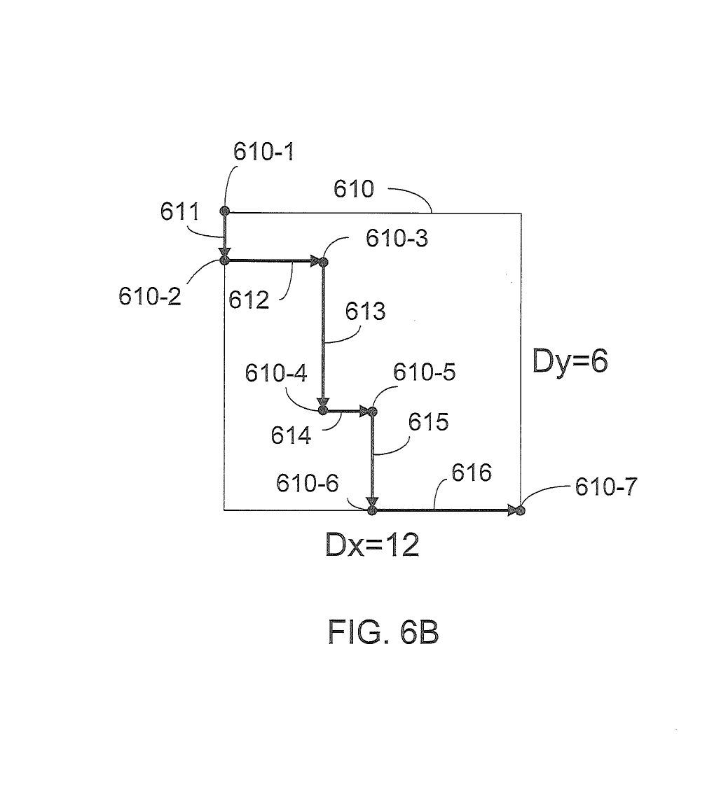

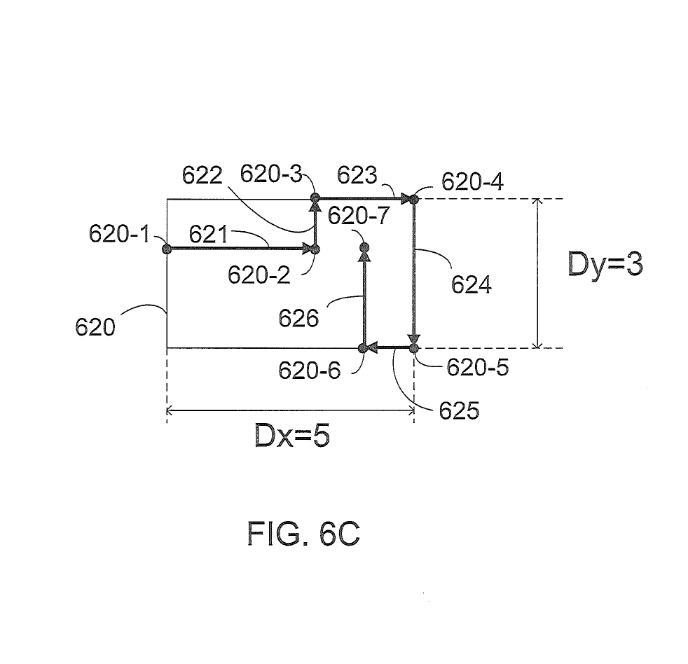

FIGS. 4A and 4B illustrate methods and steps to produce a vector history of filtered trajectory 110 across touch pad 101 such as inflection path 450. Some embodiments disclosed herein may also use envelopes of filtered trajectory 110, as described in detail in FIGS. 5A-6C below.

FIG. 5A illustrates a flowchart of method 500 for obtaining a movement envelope in touch sensitive device 100 according to embodiments disclosed herein. In step 505, a number N of points is collected from filtered trajectory 110, and placed in a circular buffer. The circular buffer may be included in memory 104, inside controller 103 (cf. FIG. 1). The value N is an integer number and may be selected according to the desired accuracy for interpreting sub-perceptive gestures and speed of response of touch sensitive device 100. A higher value of N may result in more accurate interpretation of user intent, but a slower response. The N points (X₁, Y₁) . . . (X_{N}, Y_{N}) are ordered according to their time stamps in trajectory 110. In embodiments consistent with the present disclosure, a moving envelope of the trajectory includes a circumscribing polygon for the plurality of points, N, collected in step 505. A moving envelope obtained using method 500 includes the N points collected in step 505 in the interior of the circumscribing polygon. Thus, a polygon having any number of sides may be used to obtain a moving envelope in method 500. In some embodiments the circumscribing polygon is a convex geometric object having any number of sides, each side having arbitrary lengths. A convex geometrical object is one that contains in its interior all points included in a straight line joining any two points in the interior of the object. According to some embodiments consistent with the present disclosure, the polygon used for a moving envelope may be a rectangle.

In step 510 a set of envelope characteristics is initialized using the first point (X₁, Y₁) in the buffer. A set of envelope characteristics may include Xmin, Xmax, Ymin, and Ymax values. Thus, step 510 may include the following operations. Xmin=Xmax=X₁; and Ymin=Ymax=Y₁.

In step 515 the next point in the circular buffer is selected, say (Xi,Yi). Step 520 evaluates if Xi is less than Xmin so that if it is, then step 525 reassigns Xmin=Xi and skips up to step 540. If Xi is greater than or equal to Xmin, then step 530 compares Xi to Xmax. If Xi is larger than Xmax then step 535 reassigns Xmax=Xi. If Xi is smaller than or equal to Xmax, then method 500 proceeds to step 540. Step 540 evaluates if Yi is less than Ymin so that if it is, then step 545 reassigns Ymin=Yi and skips up to step 560. If Yi is greater than or equal to Ymin, then step 550 compares Yi to Ymax. If Yi is larger than Ymax then step 555 reassigns Ymax=Yi. If Yi is smaller than or equal to Ymax, then method 500 proceeds to step 560. Step 560 verifies if all N points in the circular buffer have been processed according to steps 520 through 555. If not, then steps 515 through 555 are repeated until the last point in the buffer is reached. In step 565 the envelope dimensions are calculated: the X dimension of the envelope is Dx=Xmax−Xmin, and the Y dimension of the envelope is Dy=Ymax−Ymin. If the last point in the circular buffer is the last point in trajectory 110 as determined in step 570, then movement envelope procedure 500 is stopped in step 575. If step 575 determines that more points remain in trajectory 110, then a new point is added at the end of the circular buffer and the first point in the old buffer is deleted, in step 580. Then, method 500 is repeated from step 510 until all desired points in trajectory 110 have been included in at least one envelope.

FIG. 5B. Illustrates a series of movement envelopes in touch sensitive device 100 obtained according to methods disclosed herein. For example, FIG. 5B may be an embodiment of a method such as 500, described in detail in relation to FIG. 5A, and having a circular buffer of size N=4. Points 585-1 through 585-8 may belong to trajectory 110 retrieved from jitter filtering method 200, according to some embodiments. Points 585-1 through 585-8 are included as in method 500, resulting in envelopes 590-A, -B, -C, -D, and -E. Each envelope has x-dimension Dx-A, -B, -C, -D, and -E, respectively, and y-dimension Dy-A, -B, -C, -D, and -E. Dimensions Dx and Dy may be used by processor 102 to provide measure ‘L’ for each envelope. For example, L may be the sum of the Dx and Dy dimensions, such as L_{A}=Dx-A+Dy-A. The use of an envelope measure L will be described in further detail with reference to FIGS. 6A-C, below. Envelopes 600, 610 and 620 in FIGS. 6A-C may be obtained by a method including the steps in method 500 as described in detail above.

FIG. 6A illustrates a motion path and envelope 600 having Dy₆₀₀=0 and a Dx₆₀₀=12, according to embodiments disclosed herein. Points 600-1 through 600-7 in FIG. 6A may belong to trajectory 110 resulting from jitter filter 200, according to some embodiments. Vectors 601-606 represent displacements S between each of the points in trajectory 110 forming envelope 600. Displacement vector S was described above in the context of inflection path 450 (cf. FIG. 4B). In some embodiments, vector S may include a displacement vector between successive points in filtered trajectory 110 in the context of a moving envelope calculation. The resulting envelope measure is L₆₀₀=12+0=12. These measure and envelope dimensions indicate a consistent path with all vectors following an R 310 direction (cf. FIG. 3).

FIG. 6B illustrates a motion path and envelope 610 having Dy₆₁₀=6 and a Dx₆₁₀=12, according to embodiments disclosed herein. Points 610-1 through 610-7 in FIG. 6B may belong to trajectory 110 resulting from jitter filter 200, according to some embodiments. Vectors 611-616 represent displacements between each of the points in trajectory 110 forming envelope 610. Note that according to the embodiment illustrated in FIG. 6B, vectors 611-616 have the same lengths as vectors 601-606 in FIG. 6A. However, in the embodiments illustrated in FIG. 6B the direction of vectors 611-616 is different from that of FIG. 6A, resulting in different Dx and Dy dimensions for envelope 610. The resulting measure is L₆₁₀=12+6=18.

FIG. 6C illustrates a motion path and envelope 620 having Dy₆₂₀=3 and a Dx₆₂₀=5, according to embodiments disclosed herein. Points 620-1 through 620-7 in FIG. 6C may belong to trajectory 110 resulting from jitter filter 200, according to some embodiments. Vectors 621-626 represent displacements between each of the points in trajectory 110 forming envelope 620. Note that according to the embodiment illustrated in FIG. 6C, vectors 621-626 have the same lengths as vectors 601-606 in FIG. 6A and vectors 611-616 in FIG. 6B. However, in the embodiment illustrated in FIG. 6C the direction of vectors 621-626 is different from that of FIGS. 6A-B, resulting in different Dx and Dy dimensions for envelope 620. The resulting measure is L₆₂₀=5+3=8. FIG. 6C may be a sub-perceptive gesture indicating a ‘hunting’ intention by the user. Starting at the left, the user is trying to move to endpoint 620-7 but overshoots, moving to a position that is higher and to the right of the target (620-4). The user then moves down to reach point 620-7 but goes too far and overshoots again (620-5). The user moves leftward (625), aligning with the target (620-6), and then upward (626), finally hitting the target 620-7. The resulting path produces envelope 620 having less than ⅔ the size of envelope 600 (cf. FIG. 6A) and 610 (cf. FIG. 6B), using the same set of vector lengths 621-626. In such case a small value of L may indicate a ‘hunting’ action by the user.

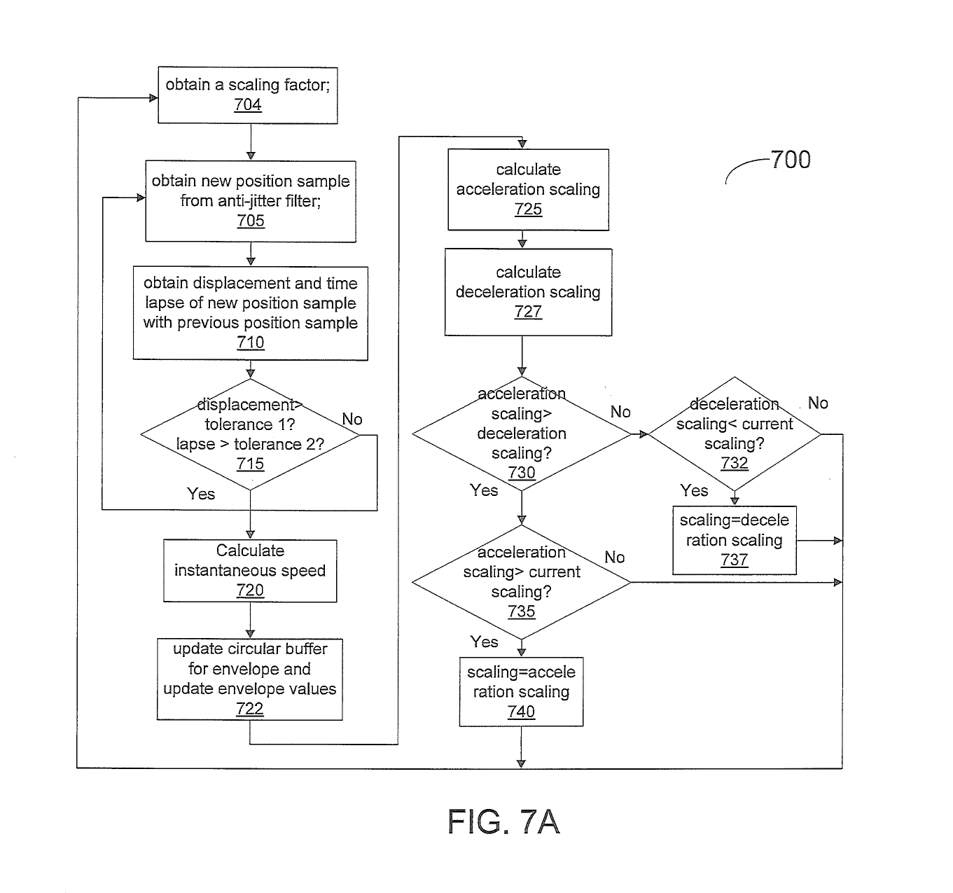

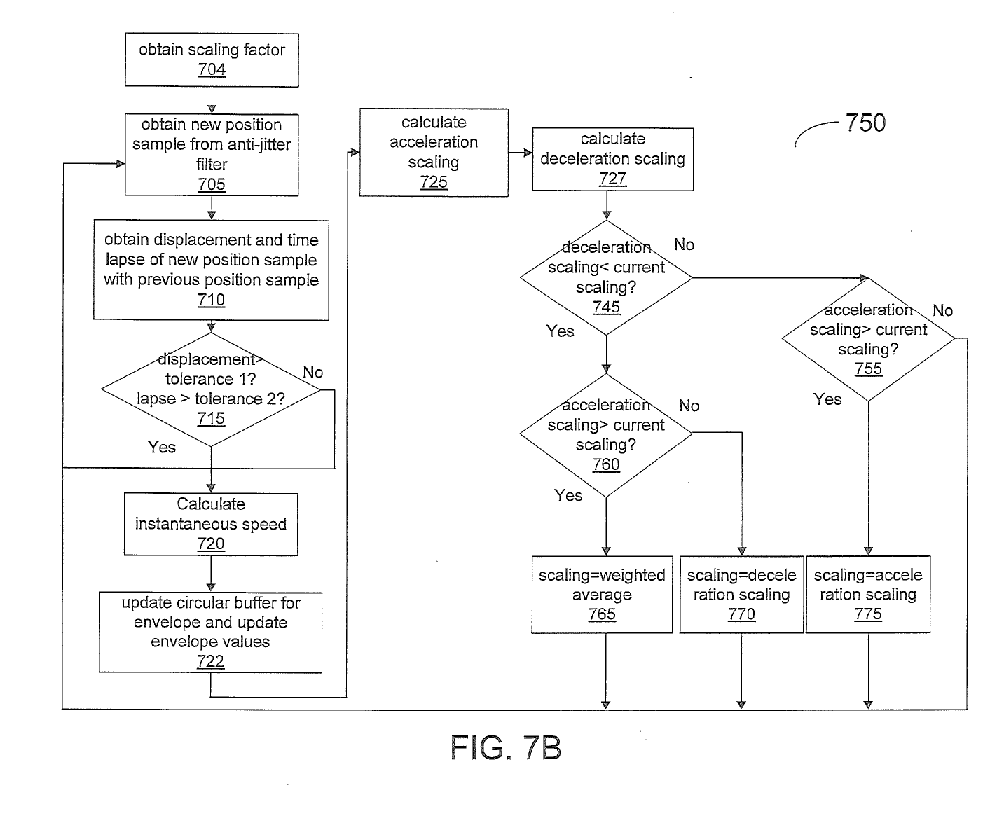

According to embodiments disclosed herein, it may be desirable to provide a sensing configuration for touch sensor 100 that combines inflection path method 400 and moving envelope method 500. For example, some embodiments may use the instantaneous speed measurement vₛ in method 400 to increase scaling factor F 105. In such embodiments, inadvertently slower movements within a full stroke of finger 170 inherit F 105 from a faster predecessor stroke. Some embodiments may also include envelope measures L obtained consistent with method 500 to reduce scaling factor F 105. Such a configuration will be described in more detail in relation to FIG. 7A, below.

FIG. 7A illustrates a flowchart of method 700 for obtaining a scaling factor in touch sensitive device 100 using two terms, according to embodiments disclosed herein. A first term may be the instantaneous speed vₛ in an inflection path (cf. FIG. 4A). A second term may be a measure L from a moving envelope calculation (cf. FIG. 5A). In step 704 a first scaling factor F 105 is obtained. In some embodiments, a first scaling factor F 105 may be a scaling factor mapping area S₁×S₂ in touch pad 101 to approximately 50% of area D₁×D₂ in display 150. Some embodiments may have a first factor F 105 mapping area S₁×S₂ in pad 101 to approximately 100% of area D₁×D₂ of display 150. Further, some embodiments may use a first factor F 105 equal to the last value stored in memory 104. In step 705, a position sample from a jitter filtering method is obtained by processor 102. A jitter filtering method may be as method 200 (cf. FIG. 2A) performed by processor 102. Position samples resulting from the jitter filter method may be stored in memory 104 and provided to processor 102 in step 705.

In step 710 displacement vector S is obtained using the new position sample and the previous position sample provided by memory 104 (cf. step 425 in FIG. 4A). Step 710 may also include the calculation of a time lapse τₛ between the new position sample and the previous position sample, using time stamps associated to each position sample and stored in memory 104 (cf. step 425 in FIG. 4A). In step 715 the size of vector S, δₛ, is determined and compared to a first tolerance value 715-1. Step 715 may also include comparing τₛ to a second tolerance value 715-2. According to some embodiments, if δₛ is smaller than the first tolerance and τₛ is shorter than the second tolerance value, then the method starts again from step 705 as described above.

In some embodiments, once either one of the conditions δₛ larger than tolerance 1 and τₛ larger than tolerance 2 is satisfied, then an instantaneous speed vₛ=δₛ/τₛ is calculated in step 720. In step 722 the circular buffer for envelope calculation is updated with the new sample point of step 705. With the updated buffer, new envelope dimensions Dx, Dy, and measure L may be obtained in step 722. Having an instantaneous speed, acceleration scaling factor AF 701 may be obtained in step 725. Scaling factor AF 701 is obtained from a product of speed vₛ=δₛ/τₛ and a pre-selected acceleration factor. Scaling factor AF 701 may have values from 1% or less, up to 100%. A value of 100% for AF 701 maps pad 101 having area S₁×S₂ into the entire display 150 having area D₁×D₂ (cf. FIG. 1). A value of 1% for AF 701 maps pad 101 having area S₁×S₂ into an area of size 0.01×D₁×D₂ in display 150. AF 701 may be determined so that for vₛ in a middle range of speeds, a 50% scaling factor is obtained, for vₛ in an upper range of speeds AF 701 is higher than 50%, and for vₛ in a lower range of speeds AF 701 lower than 50% is obtained. A lower, middle, or higher range of speed values may be established according to prior user history in some embodiments. In some embodiments, a lower, medium and higher range of speed values may be determined according to the application of touch sensitive device 100 and the dimensions of touch pad 101.

Having envelope dimensions, deceleration scaling factor DF 702 may be obtained in step 727. DF 702 is obtained from the product of envelope measure L and a pre-selected deceleration factor. Envelope measure L may be a sum of an x-dimension and a y-dimension of an envelope, L=Dx+Dy, or simply either one of the X and the Y dimensions in the envelope.

In step 730, AF 701 is compared to DF 702. If AF 701 is greater than DF 702 then AF 701 is compared to current scaling factor F 105 in step 735. If AF 701 is greater than F 105, then a new scaling factor F 105 is selected as AF 701 in step 740 and method 700 is repeated from step 704. If AF 701 is less than or equal to F 105 then no adjustment is done to scaling factor F 105 and method 700 is repeated from step 704. If AF 701 is less than or equal to DF 702 in step 730, then in step 732 DF 702 is compared to F 105. If DF 702 is smaller than F 105, then in step 737 a new scaling factor F 105 is selected as DF 702, and method 700 is repeated from step 704. If DF 702 is greater than or equal to F 105 then no adjustment is done to F105 and method 700 is repeated from step 704.

According to embodiments consistent with methods disclosed herein, AF 701 increases F 105 and DF 702 decreases F 105. Some embodiments of method 700 may include different ways to combine acceleration scaling factor AF 701 and deceleration scaling factor DF 702 to adjust factor F 105. For example, an updated value of F 105 may be obtained as the average of AF 701 and DF 702. According to some embodiments consistent with method 700, if AF 701 is less than current F 105, AF 701 is discarded. Also consistent with method 700, if DF 702 is greater than current F 105, DF 702 is discarded. Situations may arise where DF 702 is less than F 105 and AF 701 is greater than F 105 at the same time. This will be described in detail with reference to FIG. 7B, as follows.

FIG. 7B illustrates a flowchart of method 750 for obtaining factor F 105 in touch sensitive device 100 using two terms, AF 701 and DF 702, according to some embodiments. Steps 704 through 727 are described in detail in reference to method 700 above (cf. FIG. 7A). In step 745, DF 702 is compared to the current value of F 105. If DF 702 is greater than or equal to F 105 then in step 755 AF 701 is compared to current F 105. If AF 701 is less than or equal to F 105, then the value of F 105 is unaltered and method 750 is repeated from step 704. If AF 701 is greater than F 105 in step 755 then F 105 is updated to AF 701 in step 775, and method 750 is repeated from step 704. If DF 702 is smaller than F 105 in step 745, then AF 701 is compared to F 105 in step 760. If AF 701 is less than or equal to F 105 in step 760, then F 105 is updated to be equal to DF 702 in step 770 and method 750 is repeated from step 704. If AF 701 is greater than F 105 in step 760, then a situation arises where DF 702 is less than F 105 and AF 701 is greater than F 105. Such situation may indicate an unstable finger 170 involuntarily increasing instantaneous speed. Thus, F 105 is updated with a weighted average of AF 701 in step 765, and method 750 is repeated from step 704.

According to embodiments of method 750 consistent with FIG. 7B, a weighted average of AF 701 and DF 702 in step 765 may be in proportion to their difference from F 105. For example, in some embodiments, scaling F 105 may be updated in step 765 as follows:

$$new\_F = \frac{\vert old\_F - AF \vert}{\vert old\_F - AF \vert + \vert old\_F - DF \vert} \times AF + \frac{\vert old\_F - DF \vert}{\vert old\_F - AF \vert + \vert old\_F - DF \vert} \times DF \qquad ( 2 )$$

Where ‘new_F’ is the updated value of F 105 and ‘old_F’ is the previous value of F 105.

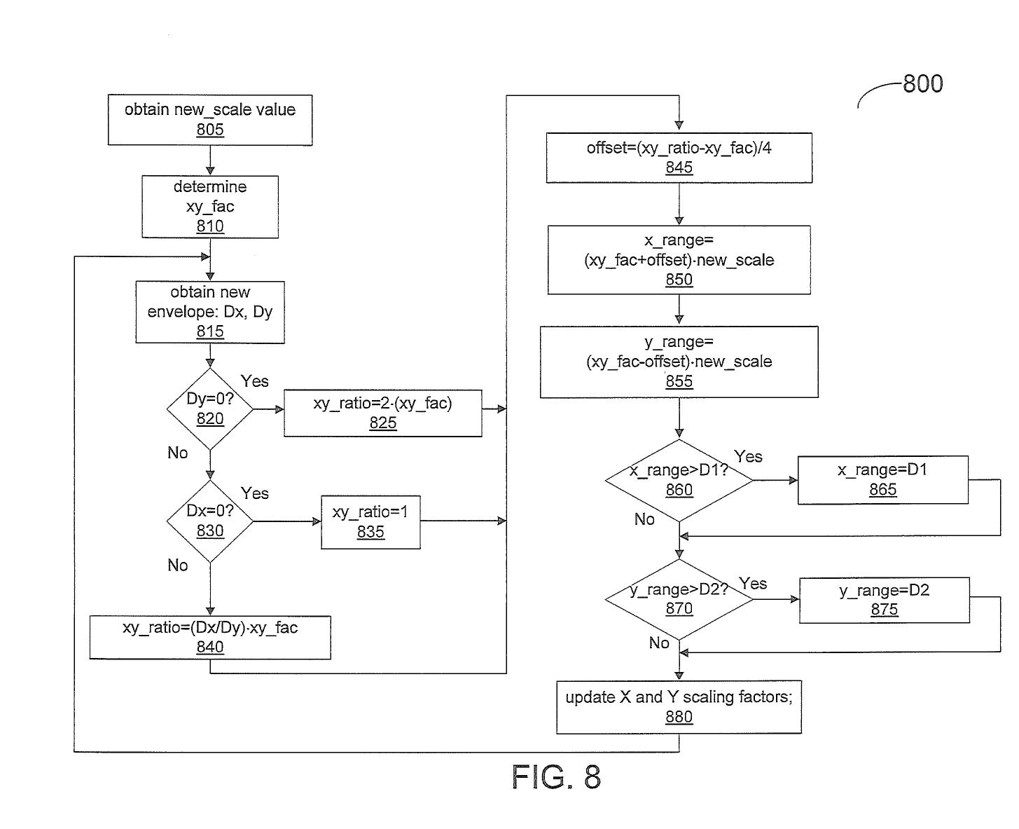

In some embodiments, the weighting average of step 765 may be determined by sub-perceptive gestures in the movement history registered in memory 104, as follows. The average length of vectors S, or their average speed vₛ=δₛ/τₛ may be used to increase the weight of AF 701 in step 765. Likewise, a history of reducing envelope measure L=Dx+Dy, may increase the weight of DF 702 in step 765. In some embodiments, step 765 may be performed over a relatively long time period in order to collect an accurate weighted average of AF 701 and DF 702. For example, if recent events indicate that the current user tends to spend an unusual amount of time hunting, weighting can be adjusted in favor of DF 702. In some embodiments, it may be desirable to adjust the scaling factor F 105 according to the direction of motion of trajectory 110. Further, some embodiments may implement a scaling factor that is different in the X and Y directions of motion across pad 101. This will be discussed in detail in relation to FIG. 8, below.

FIG. 8 illustrates a flowchart of method 800 for obtaining a direction-sensitive scaling factor 105 in touch sensitive device 100 according to embodiments disclosed herein. In step 805 ‘new scale’ factor NS 801 is selected. In step 810, value XY_fac 802 is selected. In some embodiments, a full range of XY_fac 802 values may vary from −16 to +16. In such embodiments the constant XY_fac 802 may be 16. In step 815 a new envelope of motion is obtained. According to embodiments consistent with method 800, a new point from jitter filter method 200 may be obtained in step 815 and added to a circular buffer. Thus, step 815 may include obtaining a new envelope having dimensions Dx, Dy and measure L, according to method 500. In step 820 dimension Dy is compared to zero (0). If Dy is equal to zero, then the motion has been consistently in the R-L direction (cf. FIG. 3), and a value XY_ratio 803 is selected to be two times XY_fac 802 in step 825:

XY_ratio=2×XY_{—}fac (3)

If Dy is different from zero in step 820 then Dx is compared to zero in step 830. If Dx is equal to zero, then the motion has a consistent trend in the U-D direction (cf. FIG. 3) and XY_ratio 803 is set to one (1). If Dx is different from zero in step 830, then XY_ratio 803 is obtained from XY_fac in step 840 as follows:

XY_ratio=(Dx/Dy)×XY_fac (4)

Once XY_ratio 803 has been determined in either of steps 825, 835, or 840, then offset 804 is determined in step 845 as:

offset=(XY_ratio−XY_{—}fac)/4 (5)

In step 850, X_range 806 is obtained as:

X_range=(XY_fac+offset)×new_scale (6)

In step 855, Y_range 807 is obtained as:

Y_range=(XY_fac-offset)×new_scale (7)

In step 860, X_range 806 is compared to D₁ 161 (cf. FIG. 1). If X_range 806 is greater than D₁, then X_range 806 is updated to D₁ in step 860. If X_range 806 is smaller than or equal to D₁ in 860, then Y_range 807 is compared to D₂ in step 870. If Y_range 807 is greater than D₂, then Y_range is updated to D₂ in step 875. In step 880, scaling factors for the x-coordinate (Fx 808) and the y-coordinate (Fy 809) are updated using the 806 and 807 values. In some embodiments, values 808 and 809 may be updated from 806 and 807 by using the following equations in step 880:

new_{—}Fx=(x_range/D₁)×old_{—}Fx; (8.1)

new_{—}Fy=(y_range/D₂)×old_{—}Fy; (8.2)

Once updated values 808 and 809 are obtained, processor 102 may use the updated values to obtain display point (X′,Y′) based on touch pad point (X,Y) as follows:

X′=Ox+Fx·X (9.1)

Y′=Oy+Fy·Y (9.2)

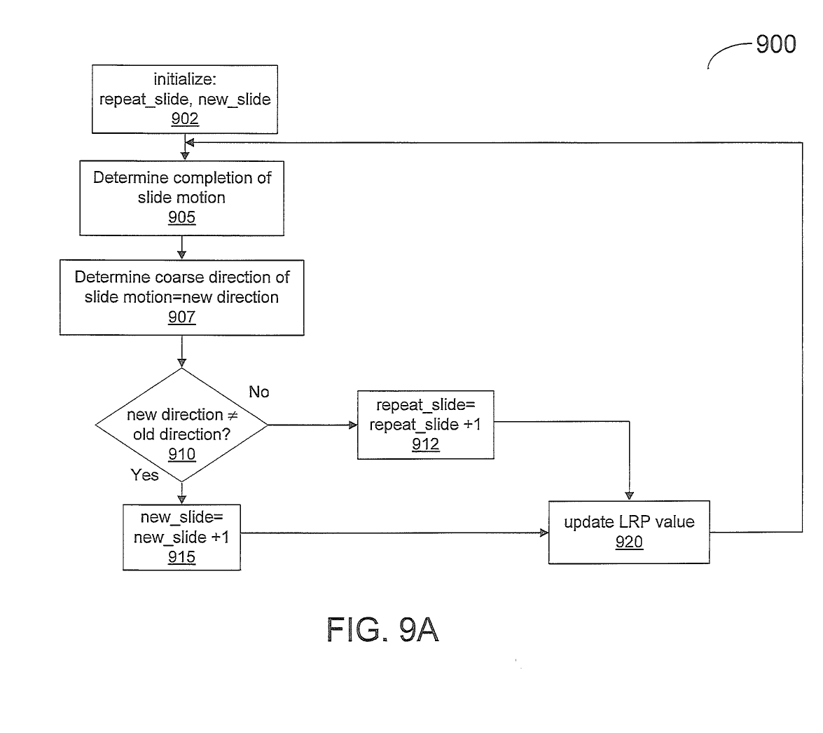

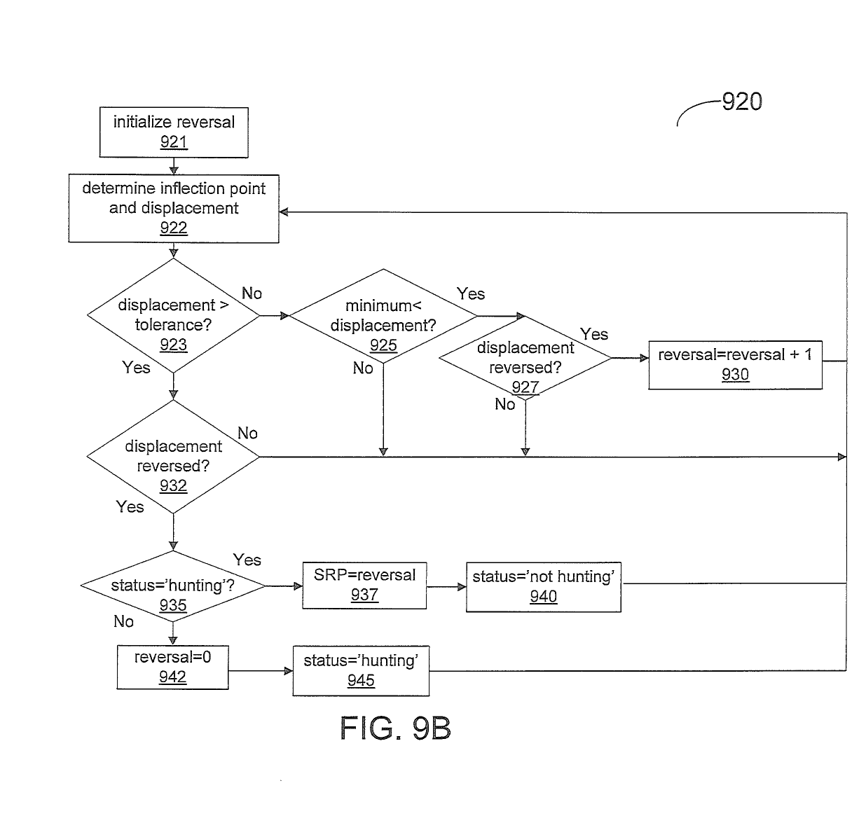

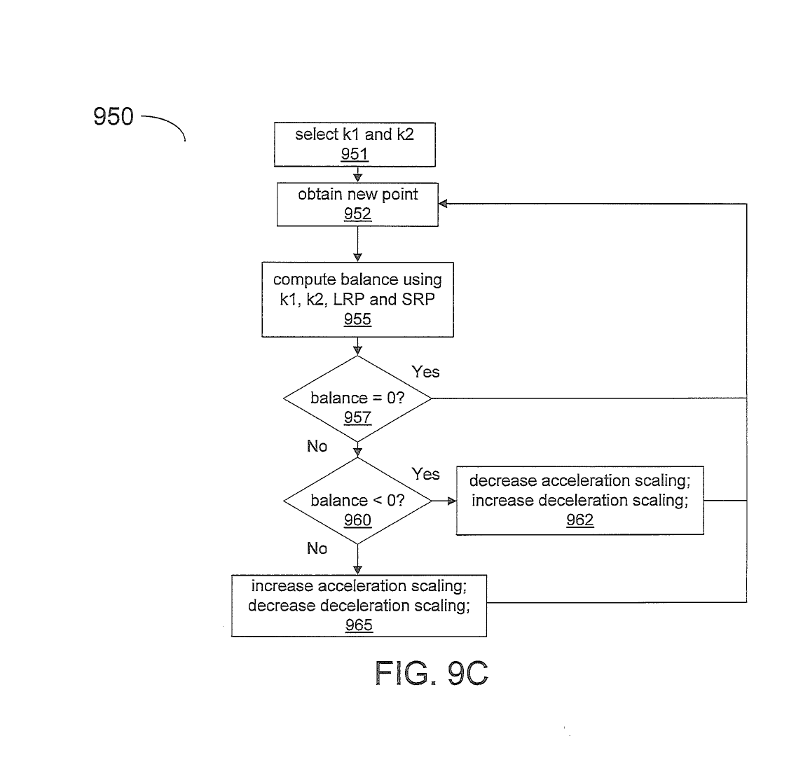

Some embodiments of adaptive scaling disclosed herein provide fast, long-range movement and comfortable, short-range focus movement. Fast long-range movement and comfortable short-range movements are complementary, thus a control process may use a balanced approach. A two-term procedure such as methods 700 and 750 (cf. FIGS. 7A and 7B, respectively), may provide a satisfactory compromise between long-range and short-range movements. In some embodiments factors AF 701 and DF 702 may be complemented with further factors to produce a more accurate determination of user intent. A long range performance factor (LRP) and a short range performance factor (SRP) may be calculated according to methods described in detail in FIGS. 9A and 9B below.

FIG. 9A illustrates a flowchart of method 900 for obtaining a user-sensitive scaling factor 105 having long range performance (LRP), according to embodiments disclosed herein. In step 902 counters ‘new_slide’ 921 and ‘repeat_slide’ 922 are initialized. In some embodiments, counters 921 and 922 may be initialized to a value of zero (0). In some embodiments, either one of counters 921 and 922 may have a value different from zero (0). In step 905, processor 102 determines the completion of a slide motion. In some embodiments, step 905 may be performed by determining that finger 170 no longer makes contact with touch pad 101. For example, the signal from a sensor in 101 may fall below a pre-selected touch threshold level, so that processor 102 may determine a completion of slide motion in step 905. In step 907 the coarse direction of the slide motion is determined according to chart 300 (cf. FIG. 3). In some embodiments, the coarse direction of step 907 may be determined by a displacement vector joining the touch ‘down’ (first) point in the slide motion and the touch ‘up’ (last) point in the slide motion. In step 910 the coarse direction determined in step 907 (‘new direction’) is compared with a previously stored value in memory 104 or ‘old direction’ 901. If ‘new direction’ is different from old direction 901, then new_slide counter 902 is incremented by one (1) in step 915, and value 901 is updated to ‘new direction’ determined in step 907. If ‘new direction’ is not different from value 901, then value 901 is kept ‘as is’ and repeat_slide counter 903 is incremented by one (1) in step 912.

In step 920 a long range performance value (LRP) 908 is updated. In some embodiments, step 920 may include performing the following operation in processor 102:

LRP=repeat_slide/(new_slide+repeat_slide) (10)

With an updated value LRP 908, method 900 may be repeated from step 902. More generally, LRP 908 measures a percentage of slide motions that repeat the previous slide direction. A lower LRP 908 value may indicate better response of touch sensitive device 100 to user intent of moving cursor 151 through long distances.

FIG. 9B illustrates a flowchart of method 920 for obtaining a user-sensitive scaling factor having a short range performance (SRP), according to embodiments disclosed herein. In step 921 a value for ‘reversal’ counter is initialized. In some embodiments, ‘reversal’ is set to zero (0) in step 921. In step 922 touch point (X,Y) is obtained and it is determined if it is an inflection point I. In some embodiments, processor 102 obtains point (X,Y) after performing jitter filtering method 200 (cf. FIG. 2A). In step 922 inflection point I includes a displacement S to a most recent point (X,Y), S having a direction and a length δ_{sI}. In step 923 length δ_{sI} is compared to tolerance 923t. If δ_{sI} is less than or equal to 923t then in step 925 δ_{sI} is compared to minimum value 925min. If δ_{sI} is greater than 925min in step 925 then the direction of S (‘new direction’) is compared to the old direction in step 927, according to chart 300 (cf. FIG. 3). The old direction of vector S is a value stored in memory 104 according to chart 300 corresponding to a previous value of S. If vector direction is reversed; that is, old direction is opposite to ‘new direction,’ then reversal counter is incremented by one (1) in step 930 and method 920 is repeated from step 922. If ‘new direction’ is not reversed according to step 927, then method 920 is repeated from step 922 leaving reversal counter unchanged. If δ_{sI} is less than or equal to 925min in step 925, then method 920 is repeated from step 922 leaving reversal counter unchanged.

If δ_{sI} is greater than 923t in step 923 then ‘new direction’ is compared to ‘old direction’ in step 932. If ‘new direction’ is not opposite to ‘old direction’ then method 920 is repeated from step 922, leaving reversal counter unchanged. If ‘new direction’ is reversed in step 932 then status variable 935stat is compared to the value ‘hunting’ in step 935. If 935stat is ‘hunting’ then SRP value 945 is updated to reversal counter in step 937, and 935stat is updated to ‘not hunting’ in step 940. Method 920 is repeated from step 922, leaving reversal counter unchanged. If 935stat is ‘not hunting’ in 935, then reversal counter is set to zero (0) in step 942 and 935stat is updated to ‘hunting’ in step 945. Method 920 is repeated from step 922.

A higher value of SRP 945 indicates an increased degree of ‘hunting’ by the user. Thus, lower SRP 945 may indicate better response of touch sensitive device 100 to user intent to move the cursor short distances. LRP 908 and SRP 945 have no units or inherent absolute values according to some embodiments. LRP 908 and SRP 945 may be compared by subtraction or division, yielding a measure of their balance. A balance between LRP 908 and SRP 945 may be consistent with user intent. Scaling coefficients may be continuously adjusted by processor 102 to achieve a particular balance level. One possible realization of this balance is described in detail in relation to FIG. 9C below.

FIG. 9C illustrates a flowchart of method 950 for obtaining scaling factors balancing LRP 908 and an SRP 945, according to embodiments disclosed herein. Method 950 may be performed by processor 102 using data provided by touch pad 101 and stored in memory 104. In step 951, pre-selected coefficients k1 and k2 are obtained. In step 952 a new point (X, Y) is obtained. In some embodiments, new point (X, Y) may be the result of a jitter filter procedure such as method 200 performed by processor 102 using touch sensing data provided by pad 101. In step 955 balance 971 is computed using k1, k2, LRP 908, and SRP 945. According to embodiments consistent with method 950, balance 971 may be computed according to the following formula:

balance=k1·LRP−k2·SRP (11)

In step 957, balance 971 is compared to zero (0). If balance 971 is equal to zero, then no adjustments are performed and method 950 is repeated from step 952. If balance 971 is found to be less than zero in step 960, then processor 102 decreases AF 701 and increases DF 702 in step 962. The consequent decrease in the weighting of acceleration (FIG. 7A step 725) and increase in the weighting of deceleration (FIG. 7A step 727) in the scaling method described by FIG. 7A may decrease the effort required to achieve a target position. This in turn may result in a decrease of SRP 945 (indicating better short-range performance)—cf. the description of method 920 in FIG. 9B—and an increase of LRP 908 (indicating worse long-range performance)—cf. the description of method 900 in FIG. 9A—resulting in balance 971 moving toward zero (cf. Eq. 11). If balance 971 is found to be greater than zero in step 960, then processor 102 increases AF 701 and decreases DF 702 in step 965. The resulting increase in the weighting of acceleration (FIG. 7A step 725) and decrease in the weighting of deceleration (FIG. 7A step 727) in the scaling method described by FIG. 7A may decrease the effort required to move long distances. This in turn may result in a decrease of LRP 908 (indicating better long-range performance)—cf. the description of method 900 in FIG. 9A—and an increase of SRP 945 (indicating worse short-range performance)—cf. the description of method 920 in FIG. 9B—resulting in balance 971 moving toward zero (cf. Eq. 11). Method 950 is then repeated from step 952.

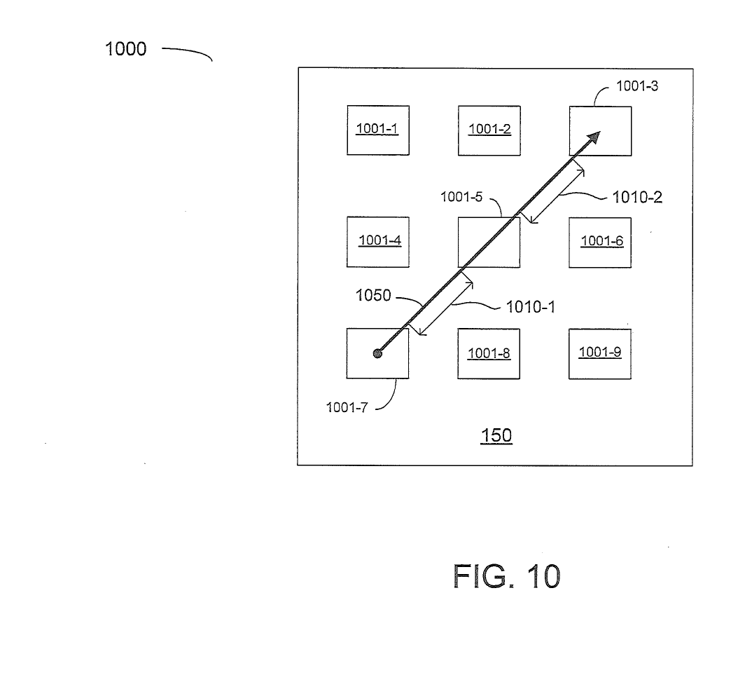

Adaptive scaling based on touch movement patterns such as instantaneous speed and envelope consistent with method 950 described above affords robust control of touch sensitive device 100. Some embodiments of touch sensitive device 100 may include a controller 103 able to single out special situations commonly arising in the use of device 100. Some embodiments of controller 103 may include target-aware scaling described in relation to FIG. 10 below.

FIG. 10 illustrates display 150 coupled to touch sensitive device 100 and using target-aware scaling method 1000, according to embodiments disclosed herein. Display 150 may include multiple targets 1001 separated by inactive screen areas. FIG. 10 illustrates a number of target objects 1001-1 through 1001-9 placed on display 150. Targets 1001 can vary in size and, therefore, level of touch acuity required for reliable selection, while inactive areas require very little acuity. Adaptive scaling based on touch movement patterns reacts to the user's response to target arrangement. This makes the control of touch sensitive device 100 reactive, typically having a lag time. For example, a lag may appear as delayed acceleration when the user wants to move quickly and delayed deceleration causing overshoot and forcing the user to hunt for a target. If controller 103 is aware of the varying acuity requirements of display 150, it can anticipate user intent and adjust scaling appropriately.

A slide 1050 on display 150 resulting from filtered trace 110 on touch pad 101 may have a starting point on target 1001-7 and an ending point on target 1001-3. Slide 1050 crosses over targets 1001-7, 1001-5, and 1001-3, and also over inactive portions of display 150 in segments 1010-1 and 1010-2. In such a situation, controller 103 may increase F 105 in portions 1010-1 and 1010-2, and reduce F 105 when slide 1050 is crossing over, or in the vicinity of targets 1001-7, 1001-5 and 1001-3.

Consistent with some embodiments, accuracy may be enhanced by establishing a target preference. Thus, if 1001-3 were a more likely target than 1001-5 for a given user, F 105 could be kept as in inactive area 1010-1 and 1010-2 as the cursor travels over 1001-5. Knowledge of user preference for a given target may be provided to controller 103 by the application itself, or learned by controller 103 from behavior history. Accordingly, in some embodiments an unintended increase in F 105 around 1001-5 may induce an increase in ‘hunting.’ This in turn may reduce SRP 945 (cf. FIG. 9B). This may be corrected in embodiments consistent with method 950 (cf. FIG. 9C). In some embodiments, controller 103 may learn target preferences by storing in memory 104 areas of display 150 having slow finger movement, rapid direction reversals (indicating ‘hunting’), and high selection rates (by tap or other means).

Touch movement acuity to comfortably manipulate a particular display can vary. In some embodiments, coarse positioning (large F 105) may be used to select images from a thumbnail gallery. In some embodiments, an application may provide controller 103 with the level of acuity required, so F 105 is adjusted accordingly for the entire display. In embodiments consistent with method 700 (cf. FIG. 7A), to decrease acuity AF 701 may be increased. Also, a decrease in DF 702 may decrease acuity. Likewise, to increase acuity AF 701 may be decreased; and an increment in DF 702 may also increase acuity.

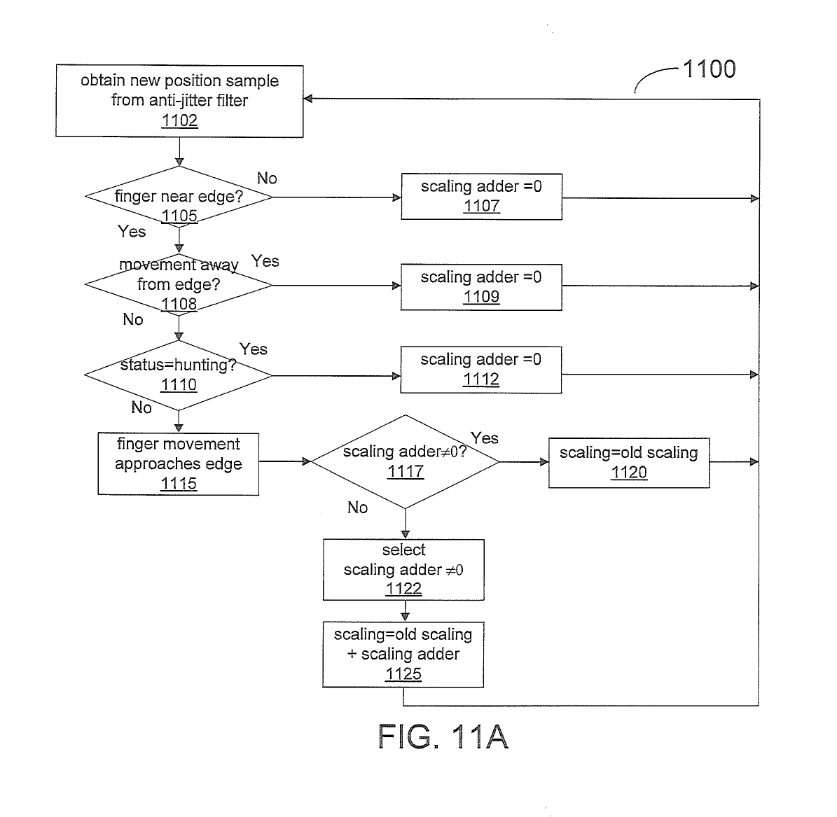

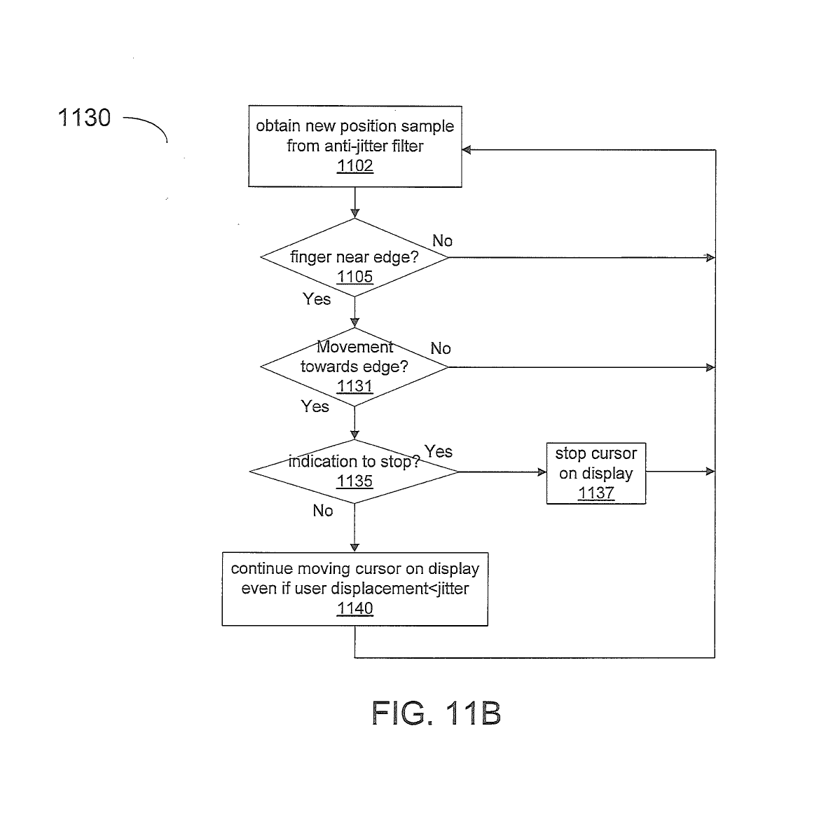

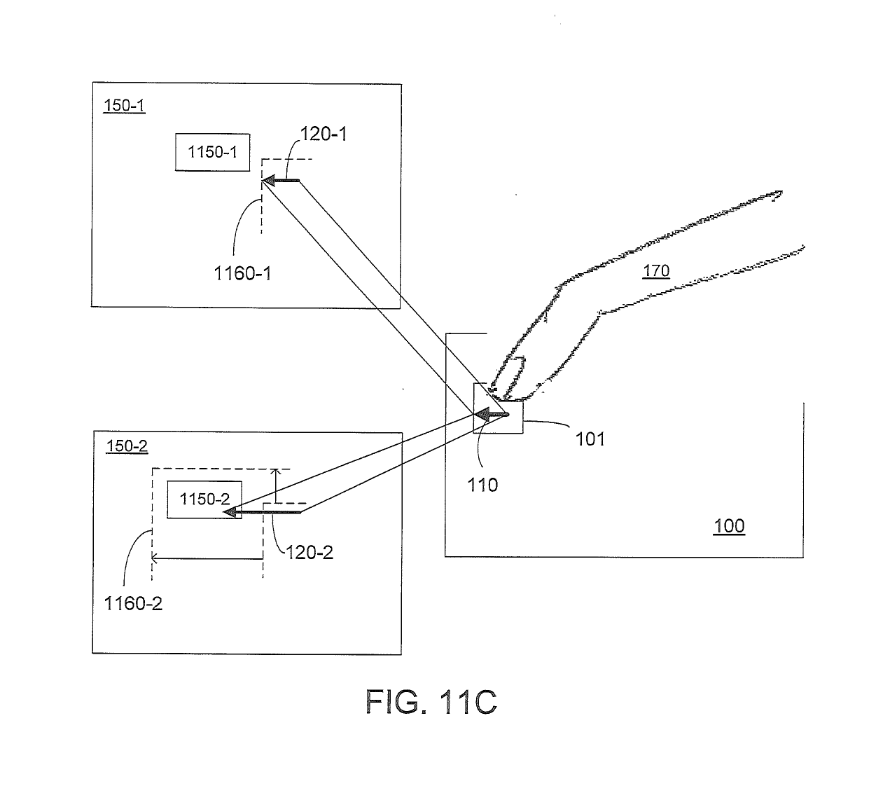

Some embodiments of controller 103 may include boundary extension detection as a special situation arising in touch sensitive device 100. This will be described in relation to FIGS. 11A-C.

FIG. 11A illustrates flow chart of method 1100 for extending a boundary in a touch sensitive device according to embodiments disclosed herein. Cursor 151 may move close to a target 1001 on display 150 (cf. FIG. 10), but finger 170 may be already on the edge of touch pad 101. Method 1100 may be used in some embodiments to correct a situation where cursor 151 is close to target 1001 but the current mapping of pad 101 to display 150 does not include target 1001.

According to embodiments shown in FIG. 11A a new position sample is obtained from jitter filter 200 in step 1102. If the finger is not near the edge of touch pad 101 in step 1105 then a scaling adder is set to zero (0) in step 1107 and method 1100 is repeated from step 1102. If the finger is near the edge of touch pad 101 in 1105, then controller 103 verifies if memory 104 has recorded a significant movement away from the edge, in step 1108. If this is the case, then the scaling adder is set to zero (0) and method 1100 is repeated from step 1102.

If no significant movement away from the edge is detected in step 1108 then status variable 1110stat is queried in step 1110. According to embodiments consistent with method 920, variable 1110stat may be the same as variable 935stat in step 935 (cf. FIG. 9B). If 1110stat is ‘hunting’ in step 1110 then the scaling adder is set to zero (0) in step 1112 and method 1100 is repeated from step 1102. If 1110stat is not ‘hunting’ in 1110 then it is determined that the finger movement intends to approach the edge of touch pad 101 in step 1115. In step 1117 the scaling adder is compared to zero (0). If scaling adder is zero (0) in step 1117, then a value different from zero (0) is assigned to the scaling adder in step 1122 and F 105 is updated by adding the scaling adder to the previous value of F 105. Method 1100 is then repeated from step 1102. If scaling adder is different from zero (0) in 1117 then F 105 is left unchanged in step 1120 and method 1100 is repeated from step 1102.

FIG. 11B illustrates a flow chart of method 1130 for extending a boundary in touch sensitive device 100 according to embodiments disclosed herein. Steps 1102 and 1105 are as described above in relation to method 1100 (cf. FIG. 11A). If finger 170 is near an edge of touch pad 101 in step 1105, then in step 1131 controller 103 establishes if finger 170 is moving towards the edge. Controller 103 may perform step 1131 by obtaining the direction of vector S between two consecutive touch positions (cf. FIGS. 3 and 4B). If no indication to stop is detected in step 1135, then controller 103 continues in step 1140 to move cursor 151 on display 150, even if the displacement of finger 170 is smaller than JR (cf. FIG. 2B). If an indication to stop is detected in step 1135, then cursor 151 is stopped on display 150 in step 1137 and method 1130 is repeated from step 1102.

According to embodiments consistent with methods disclosed herein an indication to stop in step 1135 may be any movement of finger 170 opposite to the current direction of motion. This may be detected by comparing the direction of a current displacement vector S with the direction of a displacement vector S stored in memory 104. In some embodiments, an indication of user intent to stop in step 1135 may be obtained by a decrease in touch pressure. This may be provided by measurement from a pressure transducer coupled to touch pad 101, or by estimating the touch area in touch pad 101. A reduction of the touch area may be an indication to stop in step 1135.

FIG. 11C illustrates display 150 coupled to touch sensitive device 100 using a boundary extension method according to embodiments disclosed herein. Finger 170 is moving towards the edge of touch pad 101 along trajectory 110. Trajectory 110 may be a jitter filtered trajectory after controller 103 applies method 200. Display 150-1 shows a situation where F 105 is left unchanged and therefore the boundary of touch pad 101 translates into boundary 1160-1. Desired target 1150-1 may remain outside of translated boundary 1160-1 and translated trajectory 120-1 may not reach target 1150-1. In embodiments consistent with method 1100 (cf. FIG. 11A) or method 1130 (cf. FIG. 11B) F 105 may be adjusted accordingly so that target 150-2 is within translated boundary 1160-2 and translated trajectory 120-2 is able to reach over target 1150-2.

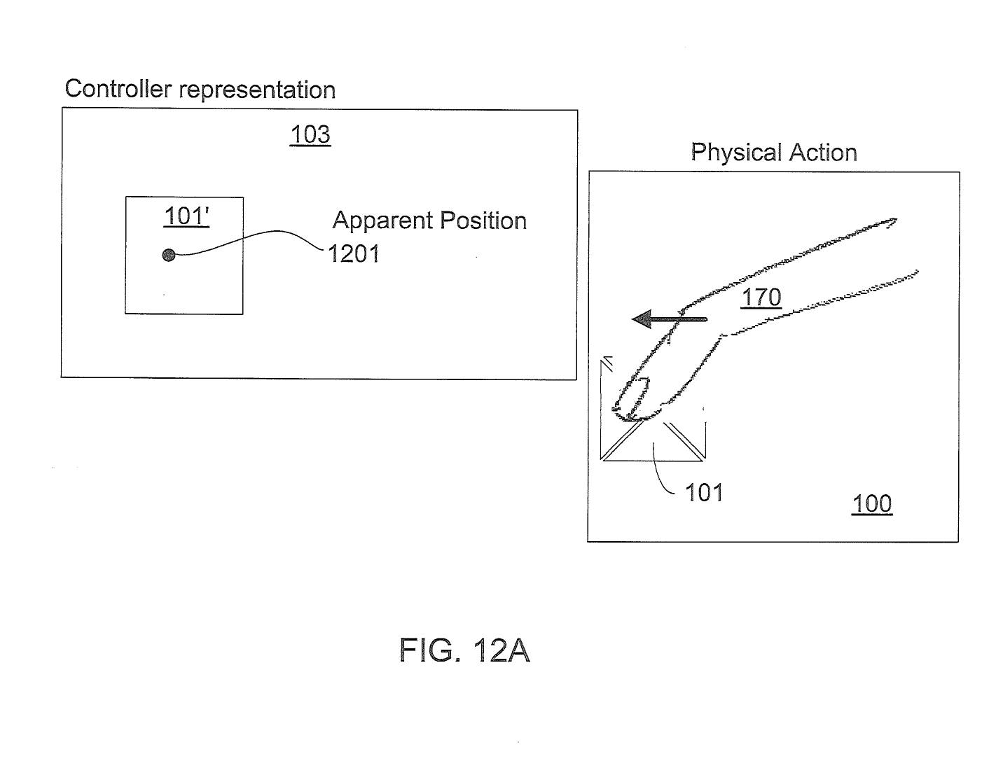

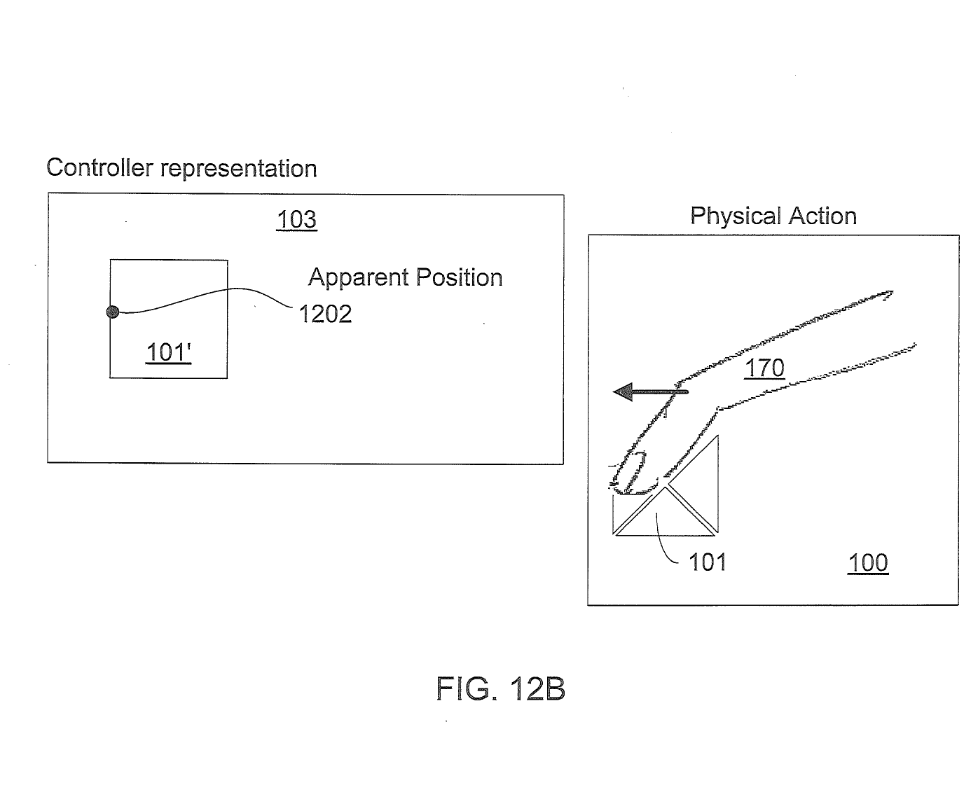

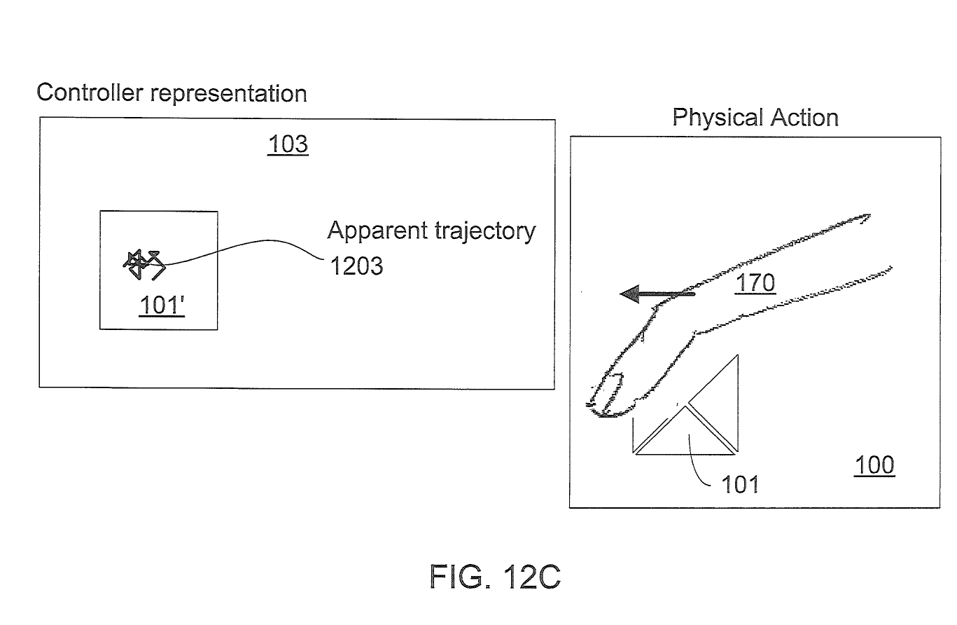

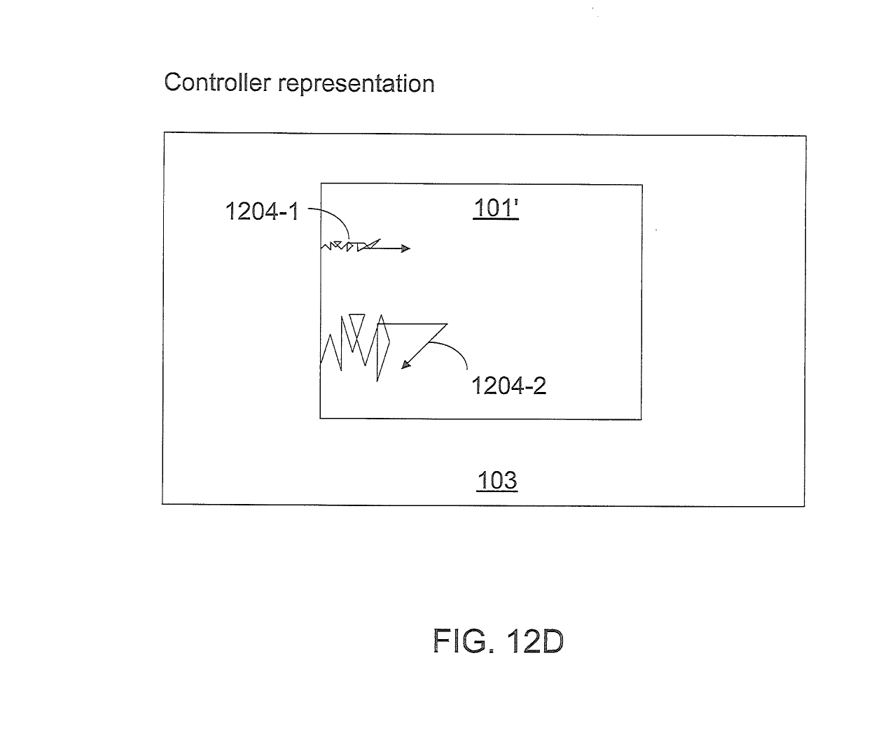

Some embodiments of touch sensitive device 100 disclosed herein may implement methods for distinguishing between finger movement and apparent position changes resulting from sensing device artifacts. Touch sensing transducers with clearly defined edges, such as optical, reliably indicate when finger 170 reaches an edge of touch pad 101. Transducers with lower edge definition, particularly capacitive, may detect edges by including further analysis in controller 103. For example, in a differential capacitance device when finger 170 is located between two opposing electrodes in touch pad 101, each electrode sees approximately the same capacitance. As finger 170 moves away from the middle, for example in the L direction (cf. FIG. 3), capacitance in the left electrode increases while that of the right electrode decreases. This may continue until finger 170 has moved close to the left edge of the left electrode. At this point capacitance on the right electrode is significantly independent of finger motion. Finger 170 may continue to affect capacitance on the left electrode. A further leftward movement by finger 170 may decrease the capacitance in the left electrode more drastically than in the right electrode. Thus, in some situations this may be interpreted erroneously as a movement in the R direction. This effect may be referred to as ‘edge rollback.’ Embodiments to resolve edge rollback situations are described in detail in relation to FIGS. 12A-D, below.

FIGS. 12A-D show a physical action of finger 170 moving across touch pad 101, and a controller representation of the movement. The controller representation is created within controller 103 as a set of (X,Y) positions that the controller will convert into (X′,Y′) positions for cursor 151 on display 150. The controller representation includes a set of points (X,Y) that form representation 101′ of the geometric configuration of touch pad 101. According to embodiments consistent with the present disclosure, touch pad 101 may be a capacitive coupled sensor including four electrodes. The four electrodes in touch pad 101 may be arranged symmetrically in U(up), D(down), L(left), and R(right) configuration. Some embodiments consistent with the present disclosure may use other type of sensor devices in touch pad 101, such as an optically coupled sensor, or a pressure transducer. While the detailed description below may refer to a capacitively coupled electrode, embodiments included herein are not limited to these specific devices.

FIG. 12A illustrates apparent position 1201 of finger 170 in touch pad 101′ coupled to touch sensitive device 100 configured to avoid an edge rollback, according to embodiments disclosed herein. In FIG. 12A finger 170 is near the center of touch pad 101 and apparent touch position 1201 accurately represents the location of finger 170 within touch pad 101′.

FIG. 12B illustrates apparent position 1202 of finger 170 in touch pad 101′ coupled to touch sensitive device 100 configured to avoid an edge rollback, according to embodiments disclosed herein. As finger 170 moves close to the left edge of touch pad 101, position 1202 accurately represents the location of finger 170 on the left edge of touch pad 101′.

FIG. 12C illustrates apparent trajectory 1203 of finger 170 in touch pad 101′ coupled to a touch sensitive device configured to avoid an edge rollback, according to embodiments disclosed herein. As finger 170 moves out to the left edge of touch pad 101 (physical action), the touch position in controller 103 follows apparent trajectory 1203, close to the central portion of touch pad 101′ (controller representation). The relatively large decrease in left electrode capacitance in touch pad 101 compared to the small decrease in right electrode capacitance makes apparent trajectory 1203 in controller 103 move toward the center of touch pad 101′. Trajectory 1203 is an artifact that may not represent the true movement of finger 170 on pad 101.

FIG. 12D illustrates apparent trajectories 1204-1 and 1204-2 of finger 170 in touch pad 101′ coupled to touch sensitive device 100 configured to avoid an edge rollback, according to embodiments disclosed herein. Trajectory 1204-1 traces the raw position path during a ‘phantom’ move from apparent position 1202 in FIG. 12B to apparent trajectory 1203 in FIG. 12C. Trajectory 1204-1 is raw data with no jitter filter 200 applied to it. In embodiments consistent with edge rollback avoidance strategy as described in FIGS. 12A-D, the jitter may be used as an indicator of user intent, as follows. Jitter in 1204-1 is random and relatively small. Trajectory 1204-1 is consistently rightward while finger 170 consistently moves leftward (cf. ‘physical action’ in FIG. 12C). Trajectory 1204-2 traces the unfiltered position path resulting from withdrawing the finger from touch pad 101 after the position shown in FIG. 12B. This type of motion may occur if the user is not intent on continuing a slide motion of cursor 151 on display 150. Random displacements in 1204-2 are substantially larger than normal jitter. The direction of trajectory 1204-2 is also random and shows no consistent orientation. If finger 170 remains on the left edge of the left electrode as in FIG. 12B, raw movement shows small random jitter vectors such as trajectory 1204-1.

Thus, a method for controller 103 to differentiate between user intent to keep a slide motion to the left of touch pad 101 and the intention to start a different slide motion may be as follows. If touch position approaches the left edge of 101′ as in positions 1201 and 1202, and then moves consistently rightward with only small random jitter as in 1204-1, this may indicate intent to keep a leftward slide motion. Some embodiments consistent with the present disclosure may use a pre-selected value for jitter threshold so that if jitter is less than or equal to the threshold then the user intent is determined to be ‘continue motion’ (leftward, according to FIG. 12 C). According to some embodiments, the jitter threshold may be determined in a calibration procedure, and thus the value of jitter threshold may vary according to application and user habits. Furthermore, some embodiments may include other sensor measurements to complement the above determination. For example, in a capacitively coupled touch sensor measuring an approximately monotonic decrease in overall capacitance may indicate finger 170 intent on keeping a leftward slide motion.

Some embodiments consistent with the disclosure herein may include high resolution differential capacitive touch sensors. In such cases, and also in other embodiments consistent with the present disclosure, phantom positioning may occur when touching finger 170 is withdrawn (untouch) from pad 101. This phantom positioning was described in detail with respect to apparent trajectory 1204-2 in FIG. 12D, above.

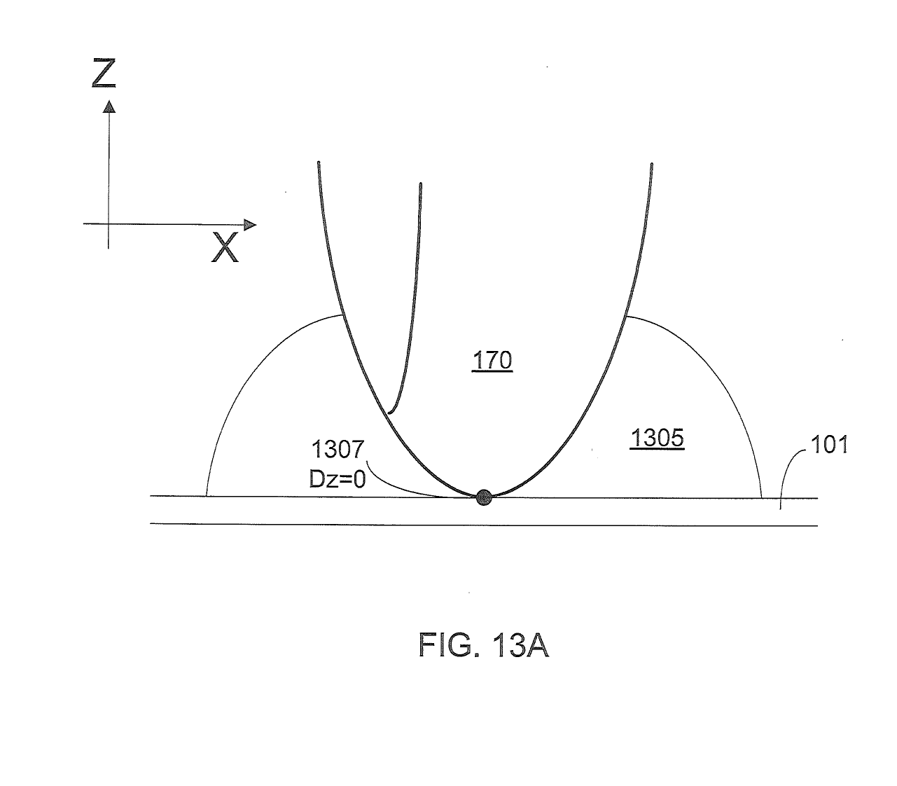

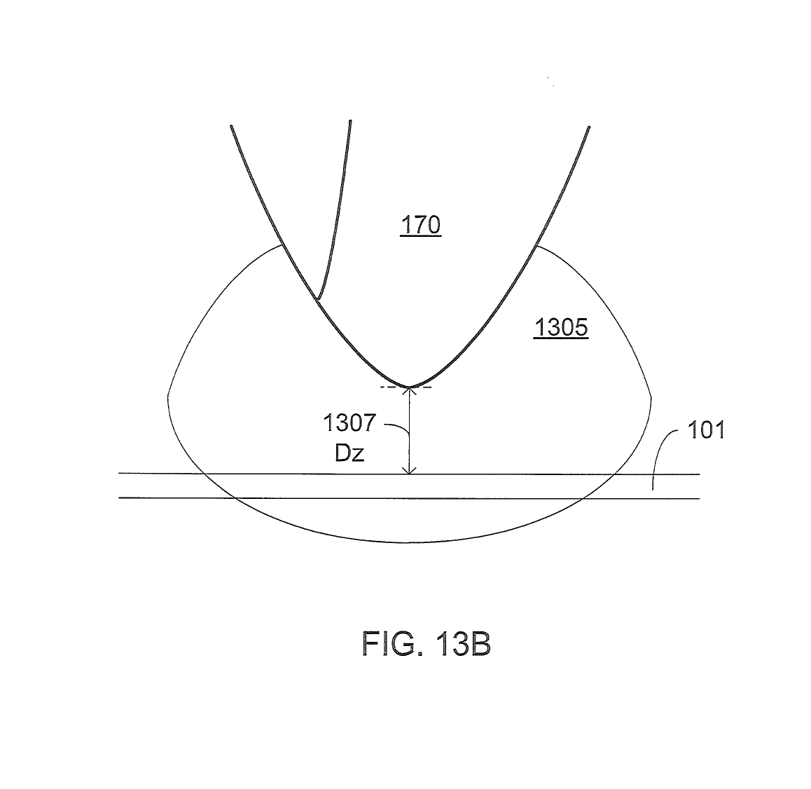

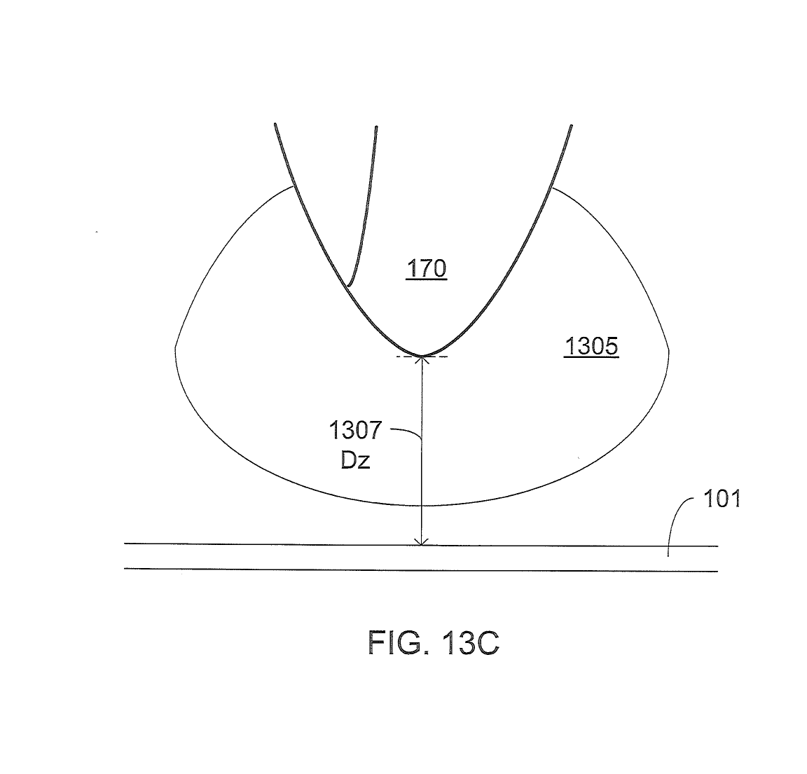

FIG. 13A illustrates a partial side view of touch sensitive device 100 configured to avoid a untouch jump according to embodiments disclosed herein. FIG. 13A shows a coordinate axis having XZ coordinates to illustrate vertical displacement Dz 1307 between finger 170 and touch pad 101. Coordinate axis XZ in FIG. 13A is consistent with a 3D ‘right-handed’ coordinate system XYZ of which the XY portion is shown in FIG. 1. The choice of coordinate axes XYZ in FIGS. 1 and 13A-C is non-limiting of the embodiments disclosed herein. The particular selection of coordinates XYZ disclosed herein is made for ease of description. As illustrated in FIG. 13A, finger 170 is in full contact with pad 101 so that Dz 1307 is zero (0). Thus, the capacitive influence range of finger 170 may encompass the entire device (if the device is small relative to the finger) or a well-defined area of the device (if the device is much larger than the finger). Finger 170 has some influence at all distances, but in some embodiments controller 103 may ignore capacitance effects below pre-selected threshold dCt. Threshold dCt determines sensitive region 1305 around finger 170. When finger 170 is in full contact with pad 101, the capacitance in pad 101 raises above dCt and controller 103 registers the finger position. In configurations where finger 170 is not fully in contact with pad 101 but is within region 1305 of pad 101, a touch may still be registered by controller 103, as shown in FIG. 13B described in detail below.

FIG. 13B illustrates a partial side view of touch sensitive device 100 configured to avoid an “untouch jump” according to embodiments disclosed herein. According to embodiments consistent with FIG. 13B distance Dz 1307 may be different from zero (0). Still, touch pad 101 may be within region 1305 from finger 170 and controller 103 registers a touch position for this configuration.

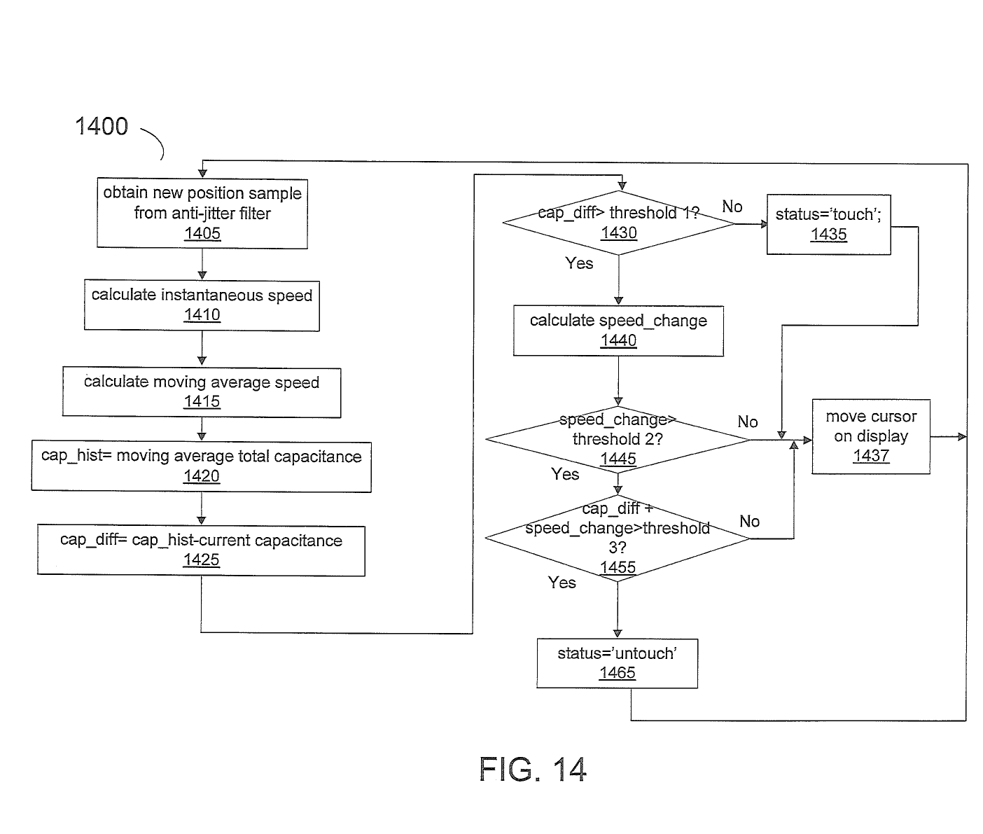

FIG. 13C illustrates a partial side view of touch sensitive device 100 configured to avoid an “untouch jump” according to embodiments disclosed herein. When finger 170 is positioned far off pad 101, as shown in FIG. 13C, region 1305 may not include touch pad 101. When finger 170 is withdrawn from the device from a configuration as in FIG. 13B to a configuration as in FIG. 13C, the capacitive effect of finger 170 transitions from above dCt to below dCt. During this transition the capacitive effect of finger 170 may vary randomly and rapidly. If controller 103 registers this motion, it may produce a phantom movement such as trajectory 1204-2 (cf. FIG. 12D). The result may be a substantial position jump at an untouched location. A method for solving this problem is described in detail in relation to FIG. 14, below.

FIG. 14 illustrates a flowchart of method 1400 for avoiding an “untouch jump” in a touch sensitive device according to embodiments disclosed herein. According to some embodiments, method 1400 may be performed by controller 103 using processor 102, data provided by touch pad 101 and stored in memory 104. In step 1405 controller 103 obtains a new finger position (X,Y) resulting from jitter filtering method 200. In step 1410 controller 103 calculates the instantaneous speed from the finger movement. In some embodiments consistent with method 400, controller 103 performs step 1410 using vₛ=δₛ/τₛ (cf. FIG. 4B). In step 1415 controller 103 calculates a moving average of speeds in prior movement points. In some embodiments controller 103 may use data stored in memory 104, to perform step 1415. In step 1420, controller 103 calculates cap_hist 1401 as a moving average of total capacitance values at different points of filtered trajectory 110. Controller 103 may perform step 1420 using data stored in memory 104. In step 1425 controller 103 calculates cap_diff 1402 as the difference between cap_hist 1401 and the total capacitance of new position (X,Y).

In step 1430 value 1402 is compared to pre-selected threshold Th 1403. If cap_diff 1402 is less than or equal to Th 1403 then a status variable is set to ‘touch’ in step 1435, cursor 151 is moved on display 150 in step 1437 and method 1400 is repeated from step 1405. Thus, when a touch position is provided through jitter filter 200 and there is no change in capacitance above threshold Th 1403, controller 103 assumes the touch continues. Note that according to embodiments consistent with method 1400 and FIG. 13B, controller 103 may register touch positions even when Dz is different from zero (0). If cap_diff 1402 is greater than Th 1403 in step 1430, then controller 103 calculates speed_change 1470 in step 1440. In some embodiments speed_change 1470 may be calculated using processor 102 to perform the following formula:

speed_change=vs/<vs> (12)

where vs is the instantaneous speed calculated in step 1410, and <vs> is the moving average speed calculated in step 1415. In step 1445 speed_change 1470 is compared to pre-selected threshold Th2 1475. If speed_change 1470 is less than or equal to Th2 1475 then controller 103 moves cursor 151 in step 1437 and method 1400 is repeated from step 1405. In step 1445 controller 103 determines that even though a capacitance change has occurred, the instantaneous speed of the movement has not changed beyond threshold Th2 1475 and assumes that the touch continues.

If speed_change 1470 in step 1445 is larger than Th2 1475 then a combination of speed_change 1470 and cap_diff 1402 is compared to Th3 1480 in step 1455. In some embodiments, the combination of speed_change 1470 and cap_diff 1402 may be a sum of the two values. If the combination of speed_change 1470 and cap_diff 1402 is less than or equal to Th3 1480 then controller moves cursor 151 in step 1437 and method 1400 is repeated from step 1405. Thus, in step 1455 controller 103 may determine that even if cap_diff 1402 is larger than Th 1403 and speed_change 1470 is larger than Th2 1475, a combination of both may not be larger than Th3 1480. Thus controller 103 may assume that the touch slide continues. If the combination of cap_diff 1402, and speed_change 1470 is larger than Th3 1480 in step 1455, then controller 103 updates the status variable to ‘untouch’ in step 1465. Method 1400 is then repeated from step 1405 without moving cursor 151 on display 150.

According to some embodiments, method 1400 may be beneficial when touch pad 101 is a small capacitive device coupled to a large display 150. Some embodiments may use method 1400 in full touch screens having essentially 100% scaling. Some embodiments may use method 1400 in touch pads which work effectively with low or substantially zero (0) acceleration. Method 1400 may also be used in embodiments where touch sensor 101 includes optical devices. In such cases phantom movement produced by a defocusing effect at untouch may be avoided using method 1400.

In the figures, elements having the same designation have the same or similar functions. Embodiments of the invention described above are exemplary only. One skilled in the art may recognize various alternative embodiments from those specifically disclosed. Those alternative embodiments are also intended to be within the scope of this disclosure. As such, the disclosure is limited only by the following claims.

1. A method for performing adaptive scaling in a touch sensitive device comprising a touch pad having a sensing range and a display having a display range comprising:
obtaining a trajectory of touch positions from the touch pad;
setting a first scaling factor;
comparing an acceleration factor to a deceleration factor, the acceleration and deceleration factors related to an acceleration and deceleration of the touch positions along the obtained trajectory and:
setting a second scaling factor to the acceleration factor if the first scaling factor is lower than the acceleration factor when the acceleration factor is greater than the deceleration factor;
setting the second scaling factor to the deceleration factor if the first scaling factor is greater than the deceleration factor and the acceleration factor is lower than or equal to the deceleration factor; and
updating a trajectory on the display using a new touch position provided by the touch pad and the second scaling factor.

2. The method of claim 1 further comprising:
obtaining at least an inflection point in the trajectory of touch positions;
obtaining a speed of motion of a touch at each point relative to one of a first trajectory point or a previous inflection point; and
setting the acceleration factor proportional to the speed of motion.

3. The method of claim 2 wherein obtaining at least an inflection point comprises:
selecting a starting point from the trajectory;
selecting a subsequent point in the trajectory separated from the starting point by a distance greater than a pre-selected distance;
obtaining a direction between the starting point and the selected point;
selecting the inflection point when the obtained direction is different from a previous direction by an amount greater than a pre-selected direction change.

4. The method of claim 3 wherein selecting the inflection point comprises comparing the direction between the starting point and the selected point using a pre-selected coarse direction.

5. The method of claim 1 wherein comparing an acceleration factor to a deceleration factor further comprises the steps of:
obtaining a speed of motion of a touch on the touch sensitive device;
computing the acceleration factor proportional to the speed of motion;
obtaining an envelope of the trajectory;
obtaining a measure for the envelope of the trajectory; and
computing the deceleration factor proportional to the measure for the envelope.

6. The method of claim 1 wherein setting a first scaling factor comprises obtaining the first scaling factor from a sensing range to cover about 50% of a display range.

7. The method of claim 1 wherein the obtaining a trajectory of touch positions further comprises filtering a jitter motion of a touch on the touch sensitive device to provide a jitter free trajectory.

8. The method of claim 7 wherein filtering a jitter motion comprises:
selecting a first point from the trajectory;
selecting a number of points from the trajectory less than a pre-selected maximum count;
obtaining a filtered position from the selected points; wherein
the selected points are closer to the first point than a pre-selected range.

9. The method of claim 8 wherein obtaining a filtered position comprises obtaining an average of the positions of the selected points.

10. The method of claim 5 wherein obtaining the envelope of the trajectory comprises:
selecting a plurality of trajectory points in a buffer;
finding a circumscribing polygon for the plurality of points;
updating the buffer with a new point in the trajectory.

11. The method of claim 10 wherein the buffer is a circular buffer.

12. The method of claim 10 wherein finding a circumscribing polygon comprises:
selecting a first maximum coordinate in a first direction and a second maximum coordinate in a second direction for the points in the buffer;
selecting a first minimum coordinate in the first direction and a second minimum coordinate in the second direction for the points in the buffer;
finding four edges of the circumscribing polygon using the first maximum coordinate, the second maximum coordinate, the first minimum coordinate, and the second minimum coordinate.

13. The method of claim 10 wherein the measure for the envelope comprises the perimeter of the circumscribing polygon.

14. The method of claim 12 wherein the measure for the envelope comprises:
a first term subtracting the first maximum and the first minimum; and
a second term subtracting the second maximum and the second minimum.

15. The method of claim 1 further comprising:
detecting a distance between a touch and an edge boundary of the touch pad;
obtaining a scaling adder;
obtaining a third scaling factor by adding the scaling adder to the second scaling factor;
updating the trajectory on the display using a new touch position provided by the touch pad and the third scaling factor.

16. The method of claim 15 wherein obtaining the scaling adder comprises:
increasing the scaling adder when the distance between the touch and the edge boundary is less than a pre-selected distance.

17. The method of claim 15 wherein obtaining the scaling adder comprises:
increasing the scaling adder when a user intent is to continue a motion towards the edge of the touch pad.

18. The method of claim 17 wherein the user intent is determined by:
measuring a touch speed;
measuring a change of direction in the touch speed; and
measuring a touch strength on the touch pad.

19. The method of claim 1 further comprising:
detecting a distance between a touch and an edge boundary of the touch pad; and
determining user intent to avoid edge rollback.

20. The method of claim 19 wherein determining user intent comprises measuring a jitter in the touch motion; further wherein
the user intent is determined to be ‘continued motion’ when the measured jitter is smaller than a pre-selected value.

21. The method of claim 19 wherein determining the user intent comprises measuring a strength of a touch signal in the touch pad; and
the user intent is determined to be ‘continued motion’ when the measured strength decreases monotonically as the touch approaches the edge boundary.

22. The method of claim 21 wherein measuring the strength of a touch signal comprises a capacitance measurement.

23. The method of claim 1 further comprising:
measuring a strength of a touch signal in the touch pad; and
determining user intent to avoid an untouch jump using the measured strength.

24. The method of claim 23 wherein determining user intent comprises:
obtaining a change of strength of a touch signal; and
determining user intent to continue a touch when the change of strength of the touch signal is smaller than a pre-selected strength change value.

25. The method of claim 23 wherein determining user intent comprises:
obtaining a change of speed of motion of a touch on the touch sensitive device; and
determining user intent to continue a motion when the change is smaller than a pre-selected speed change value.

26. The method of claim 23 wherein determining user intent comprises:
determining user intent to untouch when a condition occurs, the condition selected from the group consisting of a change of strength of a touch being larger than or equal to a pre-selected strength change value, and a change of speed of motion being larger than or equal to a pre-selected speed change value.

27. The method of claim 23 wherein measuring the strength of a touch signal comprises a capacitance measurement.

28. A method for scaling a movement on a sensitive pad to a movement on a display comprising:
obtaining a trajectory from the sensitive pad;
setting a first scaling factor;
obtaining a speed of motion from the trajectory;
obtaining a measure for a short-range movement on the sensitive pad;
computing an acceleration factor proportional to the speed of motion;
computing a deceleration factor proportional to the measure for a short-range movement;
comparing the deceleration factor to the first scaling factor, and:
setting a second scaling factor to the acceleration factor when the first scaling factor is lower than the acceleration factor when the deceleration factor is greater than or equal to the first scaling factor;
setting the second scaling factor to the deceleration factor when the first scaling factor is greater than or equal to the acceleration factor when the deceleration factor is lower than the first scaling factor;
setting the second scaling factor to a weighted average of the acceleration factor and the deceleration factor when the first scaling factor is greater than the deceleration factor and the acceleration factor is greater than the first scaling factor; and
updating a trajectory on the display with the second scaling factor.

29. The method of claim 28 wherein obtaining a measure for the short-range movement comprises:
obtaining an envelope of the trajectory;
obtaining a measure for the envelope of the trajectory; and
computing the measure for the short-range movement proportional to the measure for the envelope.

30. The method of claim 28 wherein obtaining a trajectory from the sensitive pad further comprises filtering a jitter motion of a touch on the sensitive pad to provide a jitter free trajectory.

31. The method of claim 28 wherein setting a first scaling factor comprises obtaining the first scaling factor from a sensing range to cover about 50% of a display range.

32. The method of claim 28 further comprising obtaining at least an inflection point in the trajectory from the sensitive pad and obtaining the speed of motion at each point relative to one of a first trajectory point or a previous inflection point.

33. A method for performing adaptive scaling in a touch sensitive device comprising a touch pad having a sensing range and a display having a display range comprising:
obtaining a trajectory of touch positions from the touch pad;
setting a direction factor;
adjusting a first scaling factor in a first direction and a second scaling factor in a second direction using the direction factor and a coarse direction of the trajectory; and
updating the trajectory with a new touch position in the first direction using the first scaling factor and in the second direction using the second scaling factor.

34. The method of claim 33 wherein adjusting the first scaling factor and the second scaling factor comprises:
obtaining an envelope of the trajectory; and
obtaining a first measure in the first direction of the envelope and a second measure in the second direction of the envelope.

35. A method for performing adaptive scaling in a touch sensitive device comprising a touch pad having a sensing range and a display having a display range comprising:
obtaining a trajectory of touch positions from the touch pad;
obtaining a first value proportional to a long range performance;
obtaining a second value proportional to a short range performance;
adjusting a scaling factor using a difference between the first value and the second value; and
updating a trajectory on the display with a new touch position using the scaling factor.

36. The method of claim 35 wherein the long range performance is obtained by using at least an inflection point in the trajectory of touch positions and obtaining a speed of motion of a touch at each point in the trajectory.

37. The method of claim 35 wherein the short range performance is obtained by:
obtaining an envelope of the trajectory; and
obtaining a measure for the envelope of the trajectory.

38. A method for performing adaptive scaling in a touch sensitive device comprising a touch pad having a sensing range and a display having a display range comprising the steps of:
obtaining a trajectory of touch positions from the touch pad;
setting a first scaling factor;
obtaining an acceleration factor proportional to a speed of motion of a touch;
obtaining a deceleration factor proportional to a measure of an envelope;
identifying the location of a target object in the display;
increasing the acceleration factor when the trajectory overlaps the target object;
decreasing the acceleration factor when the trajectory ceases to overlap the target object;
setting a second scaling factor to the acceleration factor when the acceleration factor is greater than the deceleration factor;
setting the second scaling factor to the deceleration factor if the first scaling factor is greater than the deceleration factor when the acceleration factor is lower than or equal to the deceleration factor; and
updating the trajectory with a new touch position provided by the touch pad and the second scaling factor.

39. A touch sensitive device coupled to a display, the touch sensitive device having a touch pad and a controller comprising:
a processor circuit coupled to receive data from the touch pad, wherein the processor circuit obtains a touch location from data provided by the touch pad;
a memory circuit coupled to receive and store the touch location from the processor circuit and form a trajectory from a plurality of touch locations, wherein:
the processor circuit obtains an instantaneous speed and an envelope having a measure from the trajectory stored in the memory circuit; and
the controller provides a signal to the display to move an indicator to a position on the display; and
the position on the display is obtained by the processor circuit using the touch location and a scaling factor computed using the instantaneous speed and the envelope measure.

40. The touch sensitive device of claim 39 wherein the processor circuit executes instructions stored in the memory circuit for performing a method comprising:
obtaining a trajectory of touch positions from the touch pad;
setting a first scaling factor;
comparing an acceleration factor to a deceleration factor;
setting a second scaling factor to the acceleration factor if the first scaling factor is lower than the acceleration factor when the acceleration factor is greater than the deceleration factor;
setting the second scaling factor to the deceleration factor if the first scaling factor is greater than the deceleration factor when the acceleration factor is lower than or equal to the deceleration factor; and
updating a trajectory on the display using a new touch position provided by the touch pad and the second scaling factor.

41. The touch sensitive device of claim 40 wherein comparing an acceleration factor to a deceleration factor comprises:
obtaining a speed of motion of a touch on the touch sensitive device;
obtaining an envelope of the trajectory;
obtaining a measure for the envelope of the trajectory;
computing the acceleration factor proportional to the speed of motion; and
computing the deceleration factor proportional to the measure for the envelope.

42. The touch device of claim 40 wherein the obtaining a trajectory of touch positions further comprises filtering a jitter motion of a touch on the touch sensitive device to provide a jitter free trajectory.

43. The touch device of claim 40 wherein the setting a first scaling factor comprises obtaining the first scaling factor from a sensing range to cover about 50% of a display range.

44. The touch device of claim 40 further comprising obtaining at least an inflection point in the trajectory of touch positions and obtaining the speed of motion at each point relative to one of a first trajectory point or a previous inflection point.

45. The touch device of claim 39 wherein the touch pad comprises a capacitively coupled touch sensor.

46. The touch device of claim 39 wherein the touch pad comprises an optically coupled touch sensor.

47. The touch device of claim 39 wherein the touch pad provides data to the processor circuit from a touch event produced by a finger.

48. The touch device of claim 39 wherein the touch pad provides data to the processor circuit from a touch event produced by a touch device selected from the group consisting of a finger, a stylus, and a pen device.
